(19) United States
(12) Patent Application Publication
(10) Pub. No.: US 2026/0004464 A1
(43) Pub. Date: Jan. 1, 2026

(54) 3D DATA DECODING APPARATUS AND 3D DATA CODING APPARATUS

(71) Applicant: SHARP KABUSHIKI KAISHA, Osaka (JP)

(72) Inventors: Sujun HONG, Osaka (JP); Yasuaki TOKUMO, Osaka (JP); Tomohiro IKAI, Osaka (JP)

(21) Appl. No.: 19/249,686

(22) Filed: Jun. 25, 2025

(30) Foreign Application Priority Data
Jun. 27, 2024 (JP) 2024-103551

(51) Int. Cl. G06T 9/00; H04N 19/70

(52) U.S. Cl. CPC G06T 9/001; H04N 19/70

(57) ABSTRACT

A 3D data decoding apparatus for decoding mesh data or point cloud data includes an atlas information decoder configured to decode atlas information from coded data in which the mesh data or the point cloud data is encoded, and a mesh reconstructor configured to decode a mesh from the coded data and the atlas information. The mesh reconstructor decodes any mesh/submesh from the coded data by using a parameter that indicates correspondence between tile information having any tile ID decoded in the atlas information decoder and submesh information having any submesh ID.

### TECHNICAL FIELD

Embodiments of the present invention relate to a 3D data coding apparatus and a 3D data decoding apparatus.

### BACKGROUND ART

A 3D data coding apparatus that converts 3D data into a two-dimensional image and encodes it using a video coding scheme to generate coded data and a 3D data decoding apparatus that decodes a two-dimensional image from the coded data to reconstruct 3D data are provided to efficiently transmit or record 3D data.

Specific 3D data coding schemes include, for example, MPEG-I ISO/IEC 23090-5 Visual Volumetric Video-based Coding (V3C) and Video-based Point Cloud Compression (V-PCC). V3C can encode and decode a point cloud including point positions and attribute information. V3C is also used to encode and decode multi-view videos and mesh videos through ISO/IEC 23090-12 (MPEG Immersive Video (MIV)) and ISO/IEC 23090-29 (Video-based Dynamic Mesh Coding (V-DMC)) that is currently being standardized. A latest draft document of the V-DMC scheme is disclosed in NPL 1.

In such 3D data coding schemes, geometries and attributes that constitute 3D data are encoded and decoded as images using a video coding scheme such as H.265/HEVC (High Efficiency Video Coding) or H.266/VVC (Versatile Video Coding).

In the case of a point cloud, a geometry image is an image corresponding to depths to the projection plane and an attribute image is an image of attributes projected onto the projection plane.

The 3D data (mesh) as described in NPL 1 includes a base mesh, a mesh displacement, and a texture-mapped image. A vertex coding scheme such as Draco can be used for coding the base mesh. Methods for encoding the mesh displacement include direct coding by arithmetic coding, in addition to a method of using video codec to encode a mesh displacement image obtained by two-dimensionally converting the mesh displacement. The texture-mapped image is encoded as an attribute image by a video codec. As a video codec, the above-described HEVC and VVC can be used.

### CITATION LIST

### Non Patent Literature

NPL 1:
Text of ISO/IEC CD 23090-29 Video-based mesh coding, ISO/IEC JTC 1/SC 29/WG 7 N0885, April 2024

### SUMMARY

### Technical Problem

In the 3D data coding scheme in NPL 1, atlas frames constituting 3D data (meshes) can be encoded and decoded in units of tiles. Although base meshes constituting 3D data (meshes) are encoded and decoded in units of submeshes, correspondence between tile information of an atlas stream and submesh information is unclear, and thus there is a problem that only specific submeshes cannot be encoded or decoded (mesh separation and mesh reconstruction).

The present invention has an object to encode and decode 3D data with high efficiency by clarifying correspondence between tile information of an atlas stream and submesh information and performing mesh separation and mesh reconstruction on any submesh in encoding and decoding of the 3D data using a video coding scheme.

### Solution to Problem

In order to solve the problem described above, a 3D data decoding apparatus according to an aspect of the present invention is a 3D data decoding apparatus for decoding mesh data or point cloud data. The 3D data decoding apparatus includes an atlas information decoder configured to decode atlas information from coded data in which the mesh data or the point cloud data is encoded, and a mesh reconstructor configured to decode a mesh from the coded data and the atlas information. The mesh reconstructor decodes any mesh/submesh from the coded data by using a parameter indicating correspondence between tile information having any tile ID decoded in the atlas information decoder and submesh information having any submesh ID.

In order to solve the problem described above, a 3D data coding apparatus according to an aspect of the present invention is a 3D data coding apparatus for encoding mesh data or point cloud data. The 3D data coding apparatus includes a mesh separator configured to separate a mesh, and an atlas information encoder configured to encode atlas information. The atlas information includes a parameter indicating correspondence between tile information having any tile ID and submesh information having any submesh ID. The mesh separator encodes a mesh/submesh by using the parameter.

### Advantageous Effects of Invention

According to an aspect of the present invention, coding efficiency for a mesh displacement can be enhanced, and 3D data can be encoded and decoded with high quality.

### BRIEF DESCRIPTION OF DRAWINGS

FIG. 1 is a schematic diagram illustrating a configuration of a 3D data transmission system according to the present embodiment.

FIG. 2 is a diagram illustrating a hierarchical structure of data of a coding stream.

FIG. 3 is a functional block diagram illustrating a schematic configuration of a 3D data decoding apparatus 31.

FIG. 4 is a functional block diagram illustrating a configuration of an atlas information decoder 302.

FIG. 5 is a functional block diagram illustrating a configuration of a base mesh decoder 303.

FIG. 6 is a functional block diagram illustrating a configuration of a mesh displacement decoder 305.

FIG. 7 is a functional block diagram illustrating a configuration of a mesh reconstructor 307.

FIG. 8 is an example of syntax of a configuration for transmitting coordinate conversion parameters at a sequence level (ASPS).

FIG. 9 is an example of syntax of a configuration for transmitting mesh data coordinate conversion parameters at a sequence level (ASPS).

FIG. 10 is an example of syntax of a configuration for transmitting coordinate conversion parameters at a picture/frame level (AFPS).

FIG. 11 is an example of syntax of a configuration for transmitting frame/tile information at a picture/frame level (AFPS).

FIG. 12 is an example of syntax of a configuration for transmitting mesh data coordinate conversion parameters at a picture/frame level (AFPS).

FIG. 13 is an example of syntax of a configuration for transmitting mesh/submesh information at a picture/frame level (AFPS).

FIG. 14 is an example of syntax of a configuration for transmitting mesh patch information at a picture/frame level (AFPS).

FIG. 15 is a diagram for illustrating operation of the mesh reconstructor 307.

FIG. 16 is a functional block diagram illustrating a schematic configuration of a 3D data coding apparatus 11.

FIG. 17 is a functional block diagram illustrating a configuration of an atlas information encoder 101.

FIG. 18 is a functional block diagram illustrating a configuration of a base mesh encoder 103.

FIG. 19 is a functional block diagram illustrating a configuration of a mesh displacement encoder 107.

FIG. 20 is a functional block diagram illustrating a configuration of a mesh separator 115.

FIG. 21 is a diagram for illustrating operation of the mesh separator 115.

FIG. 22 is an example of syntax of a configuration for transmitting mesh/submesh information at a picture/frame level (AFPS).

FIG. 23 is an example of syntax of a configuration for transmitting mesh/submesh information at a picture/frame level (AFPS).

FIG. 24 is an example of syntax of a configuration for transmitting mesh/submesh information at a picture/frame level (AFPS).

FIG. 25 is an example of syntax of a configuration for transmitting tile/submesh mapping information using SEI.

FIG. 26 is an example of syntax of a configuration for transmitting the tile/submesh mapping information using the SEI.

### DESCRIPTION OF EMBODIMENTS

Embodiments of the present invention will be described below with reference to the drawings.

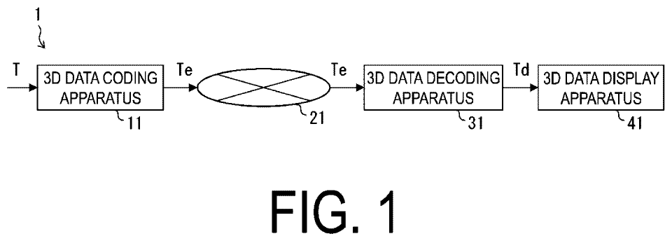

FIG. 1 is a schematic diagram illustrating a configuration of a 3D data transmission system 1 according to the present embodiment.

The 3D data transmission system 1 is a system that transmits a coding stream obtained by encoding 3D data to be encoded, decodes the transmitted coding stream, and displays 3D data. The 3D data transmission system 1 includes a 3D data coding apparatus 11, a network 21, a 3D data decoding apparatus 31, and a 3D data display apparatus 41.

3D data T is input to the 3D data coding apparatus 11.

The network 21 transmits a coding stream Te generated by the 3D data coding apparatus 11 to the 3D data decoding apparatus 31. The network 21 is the Internet, a Wide Area Network (WAN), a Local Area Network (LAN), or a combination thereof. The network 21 is not limited to a bidirectional communication network and may be a unidirectional communication network that transmits broadcast waves for terrestrial digital broadcasting, satellite broadcasting, or the like. The network 21 may be replaced by a storage medium on which the coding stream Te is recorded, such as a Digital Versatile Disc (DVD) (trade name) or a Blu-ray Disc (BD) (trade name).

The 3D data decoding apparatus 31 decodes each coding stream Te transmitted by the network 21 and generates one or more pieces of decoded 3D data Td.

The 3D data display apparatus 41 displays all or some of one or more pieces of decoded 3D data Td generated by the 3D data decoding apparatus 31. The 3D data display apparatus 41 includes a display apparatus such as, for example, a liquid crystal display or an organic electro-luminescence (EL) display. Examples of display types include stationary, mobile, and HMD. The 3D data display apparatus 41 displays a high quality image in a case that the 3D data decoding apparatus 31 has high processing capacity and displays an image that does not require high processing or display capacity in a case that it has only lower processing capacity.

### Operators

Operators used in the present specification will be described below.

“>>” is a right bit shift, “<<” is a left bit shift, “&” is a bitwise AND, “|” is a bitwise OR, “|=” is an OR assignment operator, and “∥” indicates a logical sum.

x ? y: z is a ternary operator that takes y in a case that x is true (other than 0) and takes z in a case that x is false (0).

“y . . . z” indicates a set of integers from y to z.

Log 2(x) is logarithm to base 2.

Ceil(x) is a minimum integer greater than or equal to x.

### Structure of Coding Stream Te

Prior to a detailed description of a 3D data coding apparatus 11 and a 3D data decoding apparatus 31 according to the present embodiment, a data structure of the coding stream Te generated by the 3D data coding apparatus 11 and decoded by the 3D data decoding apparatus 31 will be described.

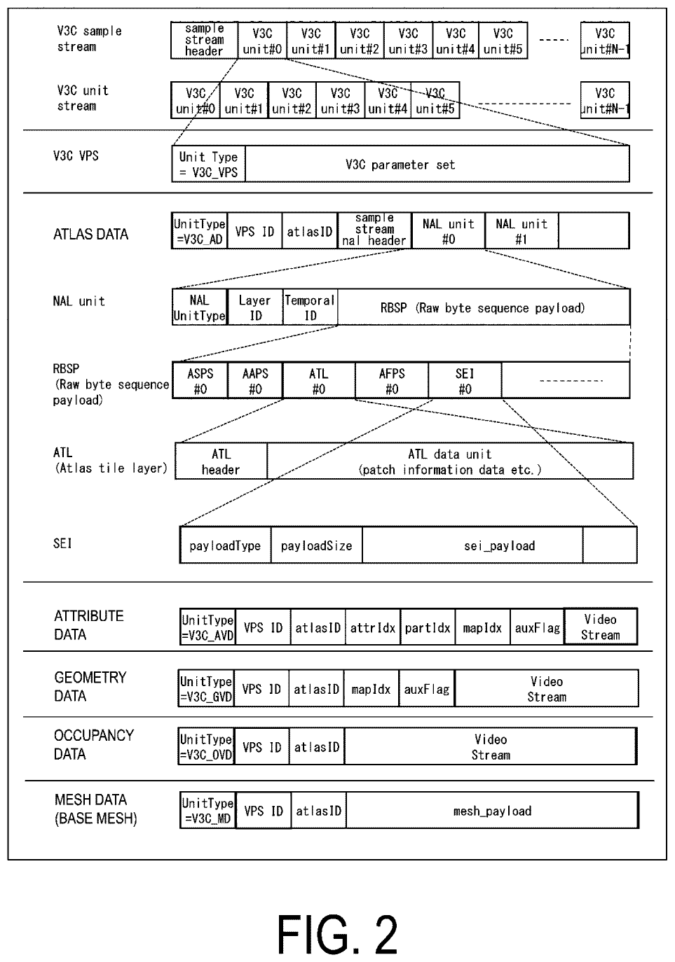

FIG. 2 is a diagram illustrating a hierarchical structure of data of the coding stream Te. The coding stream Te has a data structure of either a V3C sample stream or a V3C unit stream. A V3C sample stream includes a sample stream header and V3C units. The V3C unit stream includes a V3C unit.

Each V3C unit includes a V3C unit header and a V3C unit payload. The V3C unit header is a Unit Type that is an ID indicating the type of the V3C unit, and takes a value indicated by a label such as V3C_VPS, V3C_AD, V3C_AVD, V3C_GVD, or V3C_OVD.

In a case that the Unit Type is a V3C_VPS (Video Parameter Set), the V3C unit includes a V3C parameter set.

In a case that the Unit Type is V3C_AD (Atlas Data), the V3C unit includes a VPS ID, an atlasID, a sample stream nal header, and multiple NAL units. The atlasID is Identification (ID) and takes an integer value of 0 or more.

Each NAL unit includes a NALUnitType, a layerID, a TemporalID, and a Raw Byte Sequence Payload (RBSP).

A NAL unit is identified by NALUnitType and includes an Atlas Sequence Parameter Set (ASPS), an Atlas Adaptation Parameter Set (AAPS), an Atlas Tile Layer (ATL), Supplemental Enhancement Information (SEI), and the like.

The ATL includes an ATL header and an ATL data unit and the ATL data unit includes information on positions and sizes of patches or the like such as patch information data.

The SEI includes a payloadType indicating the type of the SEI, a payloadSize indicating the size (number of bytes) of the SEI, and an sei_payload which is data of the SEI.

In a case that the Unit Type is V3C_AVD (Attribute Video Data, attribute data), the V3C unit includes a VPS ID, an atlasID, an attrIdx which is an attribute image ID, a partIdx which is a partition ID, a mapIdx which is a map ID, a flag auxFlag indicating whether the data is Auxiliary data, and a video stream. The video stream is data encoded by HEVC, VVC, or the like. The attribute data corresponds to a texture image in the V-DMC.

In a case that the NalUnitType is V3C_GVD (Geometry Video Data, geometry data), the V3C unit includes a VPS ID, an atlasID, a mapIdx, an auxFlag, and a video stream. The geometry data corresponds to mesh displacements in the V-DMC.

In a case that the Unit Type is V3C_OVD (Occupancy Video Data, occupancy data), the V3C unit includes the VPS ID, atlasID, and the video stream.

In a case that the Unit Type is V3C_MD (Mesh Data), the V3C unit includes a VPS ID, an atlasID, and a mesh_payload. In V-DMC, this corresponds to a base mesh.

### Configuration of 3D Data Decoding Apparatus According to First Embodiment

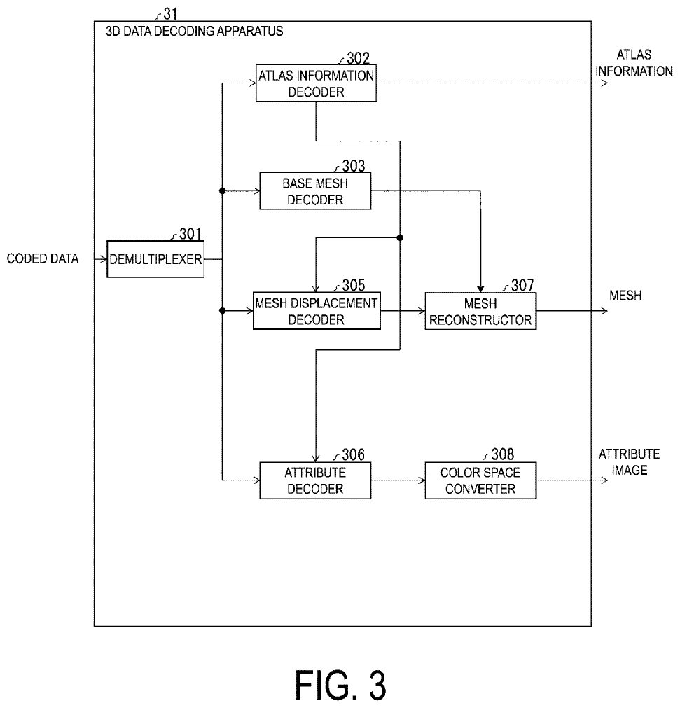

FIG. 3 is a functional block diagram illustrating a schematic configuration of the 3D data decoding apparatus 31 according to a first embodiment. The 3D data decoding apparatus 31 includes a demultiplexer 301, a submesh information decoder 3024, an atlas information decoder 302, a base mesh decoder 303, a mesh displacement decoder 305, a mesh reconstructor 307, an attribute decoder 306, and a color space converter 308. The 3D data decoding apparatus 31 receives coded data of 3D data and outputs atlas information, mesh, and an attribute image.

The demultiplexer 301 receives coded data multiplexed in a byte stream format, an ISOBMFF (ISO Base Media File Format), or the like and demultiplexes it and outputs a coded atlas information stream (an Atlas Data stream of V3C_AD and NALunits), a coded base mesh stream (a mesh_payload of V3C_MD), a coded mesh displacement stream (a video stream of V3C_GVD), and an attribute video stream (a video stream of V3C_AVD).

The atlas information decoder 302 receives the coded atlas information stream output from the demultiplexer 301 and decodes atlas information.

The atlas information decoder 302 of FIG. 3 decodes coordinate system conversion information displacementCoordinateSystem (mdu_displacement_coordinate_system) indicating a coordinate system from coded data. Note that a gating flag may also be provided separately and each piece of coordinate system conversion information may be decoded only in a case that the gating flag is 1. The gating flag is mdu_displacement_coordinate_system_enable_flag, for example.

The base mesh decoder 303 decodes a coded base mesh stream that has been encoded by vertex coding (a 3D data compression coding scheme such as, for example, Draco) and outputs a base mesh. The base mesh will be described later.

The mesh displacement decoder 305 decodes a geometry video stream (a coded mesh displacement stream) that has been encoded using VVC, HEVC, or the like and outputs mesh displacements. The type of codec (video codec) used for coding is indicated by a ptl_profile_codec_group_idc obtained by decoding the V3C parameter set of coded data. This may also be indicated by a FourCC code (a four character code or a 4 CC code) indicated by a gi_geometry_codec_id[atlasID] in the V3C parameter set. The gi_geometry_codec_id[atlasID] indicates an index corresponding to the codec ID of a decoder used to decode the geometry video stream in the atlas ID. A set indicating the correspondence between the codec ID (ccm_codec_id) and its 4CC code (ccm_codec_4cc[ccm_codec_id]) may be transmitted in another codec mapping SEI (component_codec_mapping SEI). The codec may decode mesh displacements in units of segments (slices) into which each frame is further divided. HEVC and VVC can divide each frame into slices. Each slice is encoded in units of Coded Tree Units (CTUs). Note that subpictures or tiles may be used as segments instead of slices. Because these subpictures, tiles, or slices can be decoded independently, only a part of a frame can be decoded rather than decoding the entire frame. In a case that subpictures or tiles are used, a configuration in which slices are replaced with subpictures or tiles is adopted.

The mesh reconstructor 307 receives the base mesh and mesh displacements and reconstructs a mesh in 3D space.

The attribute decoder 306 decodes an attribute video stream obtained by encoding such as VVC or HEVC, and outputs an attribute image. The attribute image may be a texture image (a texture mapped image obtained by transform by a UV atlas method) expanded on a UV axis and may be in a YCbCr format. The type of codec used for coding is indicated by a ptl_profile_codec_group_idc obtained by decoding the V3C parameter set of coded data. This may also be indicated by a Four CC code indicated by an ai_geometry_codec_id[atlasID] in the V3C parameter set. The ai_geometry_codec_id[atlasID] indicates an index corresponding to the codec ID of a decoder used to decode the attribute video stream in the atlas ID.

The color space converter 308 performs color space conversion of the attribute image from a YCbCr format to an RGB format. Note that it is also possible to adopt a configuration in which an attribute video stream encoded in an RGB format is decoded and color space conversion is omitted.

### Decoding of Atlas Information

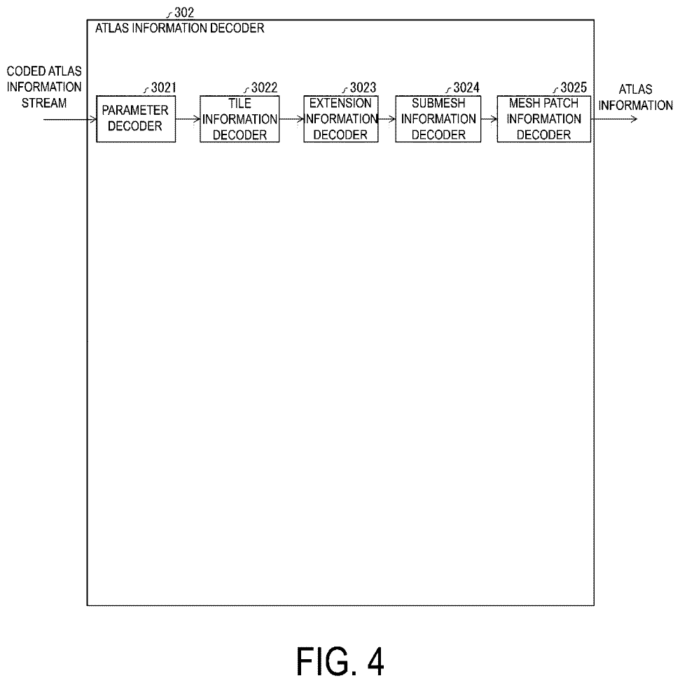

FIG. 4 is a functional block diagram illustrating a configuration of the atlas information decoder 302. The atlas information decoder 302 includes a parameter decoder 3021, a tile information decoder 3022, an extension information decoder 3023, a submesh information decoder 3024, and a mesh patch information decoder 3025.

### Decoding and Derivation of Coding Parameters

The parameter decoder 3021 decodes coding parameters from a coded atlas information stream. The coding parameters include an Atlas Sequence Parameter Set (ASPS) being a sequence-level parameter set and an Atlas Frame Parameter Set (AFPS) being a picture/frame-level parameter set.

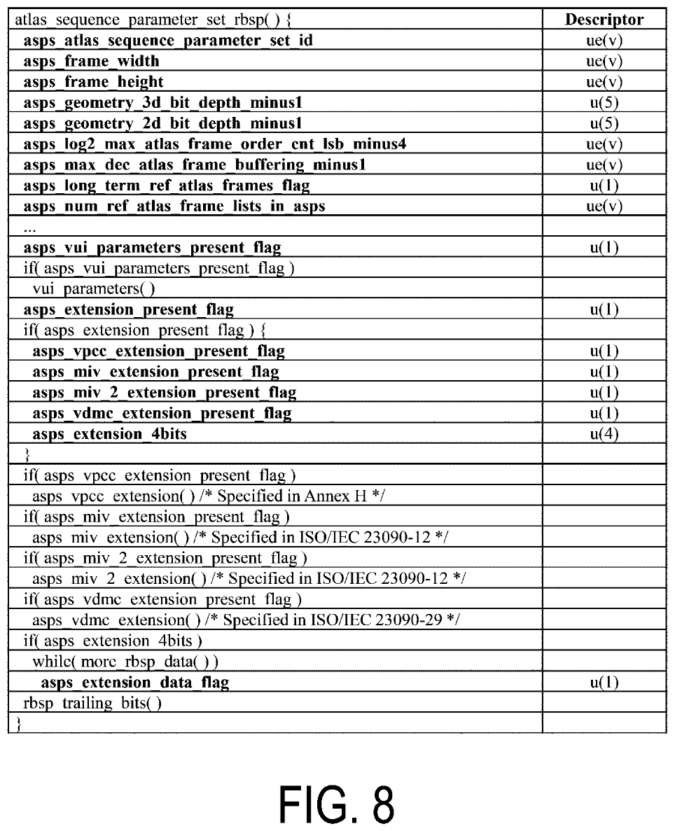

FIG. 8 is an example of syntax of an Atlas Sequence Parameter Set (ASPS) being a sequence-level parameter set. The ASPS is one of the NAL units of the atlas information, and includes syntax elements to be applied to a coded atlas information stream. Semantics of each field is as follows.

asps_geometry_3d_bit_depth_minus1: value obtained by adding 1 to asps_geometry_3d_bit_depth_minus1 indicates a bit-depth of geometry coordinates of a reconstructed volume content.

asps_geometry_2d_bit_depth_minus1: value obtained by adding 1 to asps_geometry_2d_bit_depth_minus1 indicates a bit-depth of geometry in a case of being projected onto a 2D image.

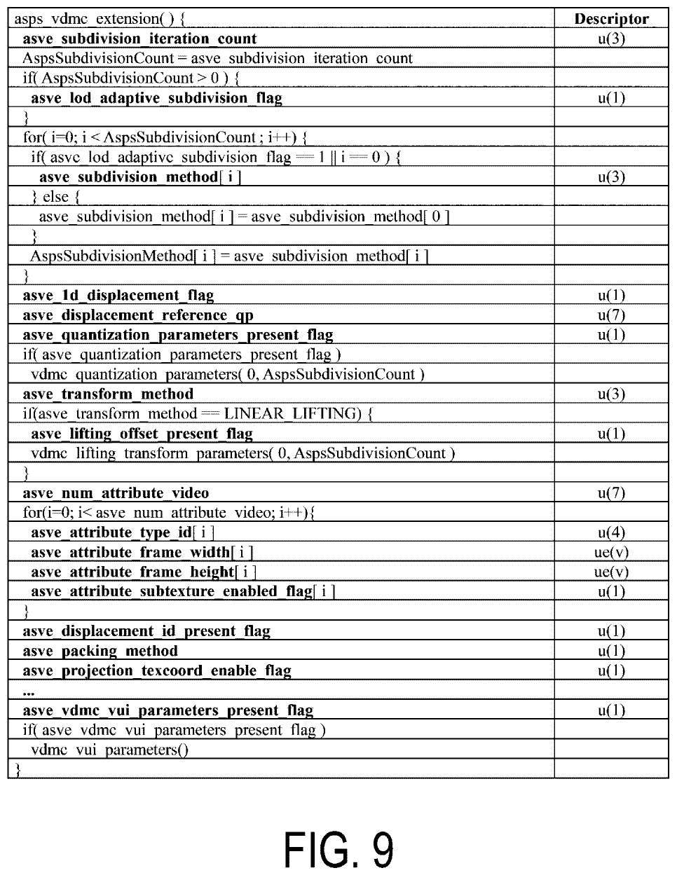

FIG. 9 is an example of syntax of ASPS Vdmc Extension (ASVE) being a sequence-level mesh data extension coding parameter set. Semantics of each field is as follows.

asve_subdivision_iteration_count: indicates the number of subdivision iterations of the mesh.

asve_1d_displacement_flag: flag indicating whether or not the mesh displacement is one-dimensional. The value being true indicates that the mesh displacement is one-dimensional. The value being false indicates that the mesh displacement is three-dimensional.

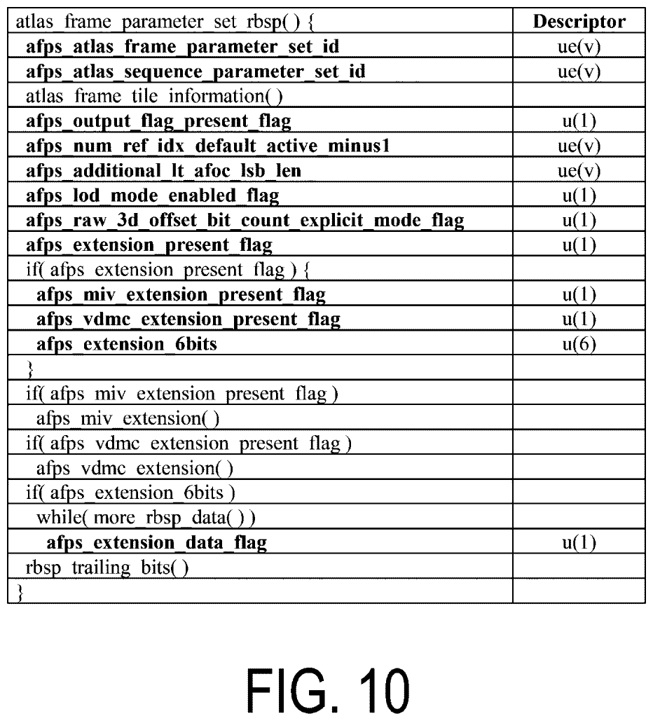

FIG. 10 is an example of syntax of an Atlas Frame Parameter Set (AFPS) being a picture/frame-level parameter set. The AFPS is one of the NAL units of the atlas information, and includes syntax elements to be applied to a coded atlas information stream. Semantics of each field is as follows. The AFPS includes atlas_frame_tile_information( ) and atlas_frame_mesh_information( ).

afps_atlas_frame_parameter_set_id: identifies the atlas frame parameter set AFPS referred to by another syntax element.

afps_atlas_sequence_parameter_set_id: indicates a value of asps_atlas_sequence_parameter_set_id of an active atlas sequence parameter set ASPS.

### Decoding and Derivation of Tile-Level Coding Parameters

Tile-level coding parameters to be decoded from coded data in the tile information decoder 3022 will be described.

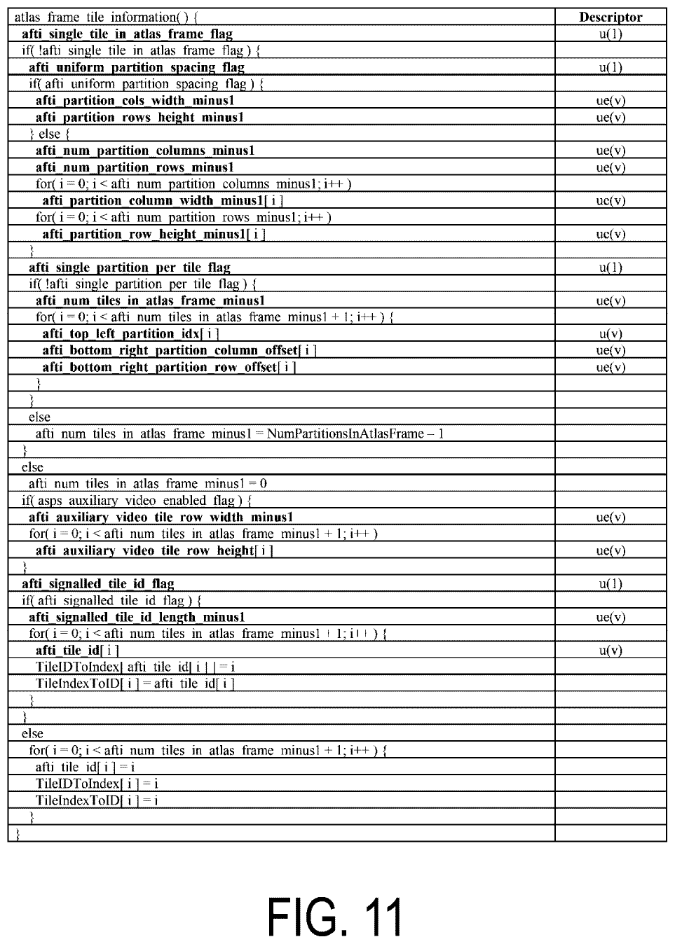

FIG. 11 is an example of syntax of tile information in the AFPS being a picture/frame-level parameter set. Semantics of each field is as follows.

afti_single_tile_in_atlas_frame_flag: flag indicating whether or not only one tile is present in each atlas frame referring to the atlas frame parameter set AFPS. In a case that the value is true, it indicates that only one tile is present in each atlas frame referring to the AFPS. In a case that the value is false, multiple (more than one) tiles are present in each atlas frame referring to the AFPS.

afti_single_partition_per_tile_flag: flag indicating whether or not only one tile partition is included in each tile referring to the atlas frame parameter set AFPS. In a case that the value is true, it indicates that only one tile partition is included in each tile referring to the AFPS, and in a case that the value is false, it indicates that multiple (more than one) tile partitions are included in each tile referring to the AFPS. In a case of not being present, the value of afti_single_partition_per_tile_flag is inferred to be equal to 1.

afti_num_tiles_in_atlas_frame_minus1: indicates the number of tiles of each atlas frame referring to the atlas frame parameter set AFPS. The value of afti_num_tiles_in_atlas_frame_minus1 shall be within a range of 0 to NumPartitionsInAtlasFrame−1. In a case of not being present, and afti_single_partition_per_tile_flag is equal to 1, the value of afti_num_tiles_in_atlas_frame_minus1 is inferred to be equal to NumPartitionsInAtlasFrame−1.

afti_signalled_tile_id_flag: flag indicating whether or not the tile ID of each tile is signaled. In a case that 1 is indicated to the flag, the tile ID of each tile is signaled. In a case that flag 0 is indicated, the tile ID is not signaled.

afti_signalled_tile_id_length_minus1: afti_signalled_tile_id_length_minus1+1 indicates a syntax element afti_tile_id[i] (in a case of being present) in a tile header and the number of bits used to express a syntax element ath_id. The value of afti_signalled_tile_id_length_minus1 shall be within a range of 0 to 15.

afti_tile_id[i]: indicates the tile ID of an i-th tile. In a case of not being present, the value of afti_tile_id[i] is inferred to be equal to i for each i within a range of 0 to afti_num_tiles_in_atlas_frame_minus1. afti_tile_id[i] not being equal to afti_tile_id[j] (a case of being equal thereto shall not be present) for all of i!=j is a bitstream conformance requirement. The 3D data decoding apparatus 31 decodes a bitstream satisfying the conformance requirement (the same applies hereinafter).

In a case of decoding and encoding afti_single_tile_in_atlas_frame_flag and afti_single_partition_per_tile_flag, the tile information decoder 3022 may decode and encode a syntax element afti_num_tiles_in_atlas_frame_minus2 indicating the number of tiles minus 2 (a value obtained by subtracting 2 from the number of tiles). Alternatively, only in a case that the value of afti_single_tile_in_atlas_frame_flag is false and the value of afti_single_partition_per_tile_flag is false, the syntax element afti_num_tiles_in_atlas_frame_minus2 indicating the number of tiles to be referred to minus 2 may be decoded and encoded. The following example may be used for semantics.

afti_num_tiles_in_atlas_frame_minus2: indicates the number of tiles of each atlas frame referring to the atlas frame parameter set AFPS. The value of afti_num_tiles_in_atlas_frame_minus1 shall be within a range of 0 to NumPartitionsInAtlasFrame−2. In a case of not being present, and afti_single_partition_per_tile_flag is equal to 1, the value of afti_num_tiles_in_atlas_frame_minus2 is inferred to be equal to NumPartitionsInAtlasFrame−2.

In the present configuration, a case that the number of tiles to be referred to is one can be expressed by afti_single_tile_in_atlas_frame_flag, and thus there is an effect that overhead for the amount of codes can be reduced by decoding and encoding the syntax element indicating the number of tiles minus 2.

### Decoding and Derivation of Extension Coding Parameters

Extension coding parameters to be decoded from coded data in the extension information decoder 3023 will be described.

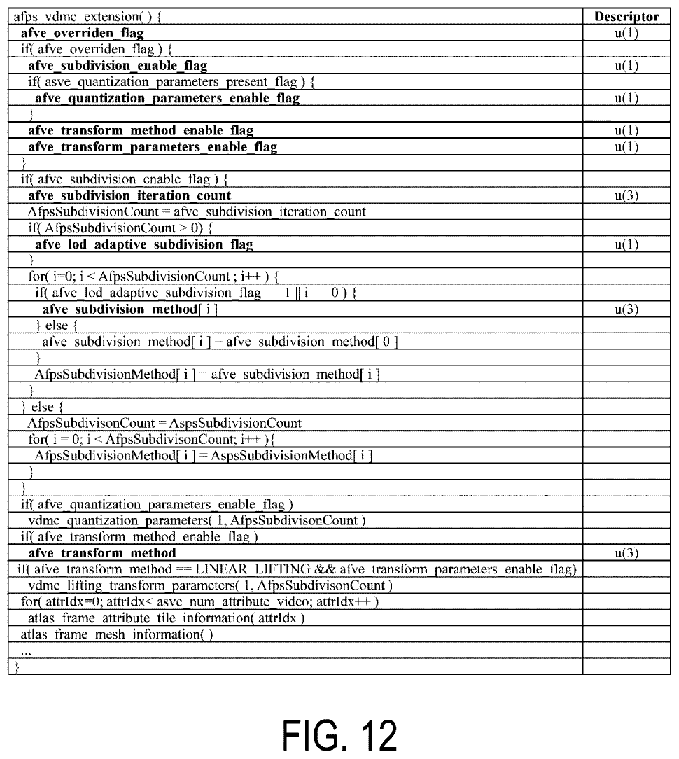

FIG. 12 is an example of syntax of mesh information in the AFPS being a picture/frame-level parameter set.

afve_overriden_flag: flag indicating whether or not the coordinate system for mesh displacements is updated. In a case that the flag is equal to true, the coordinate system for mesh displacements is updated based on the value of mdu_displacement_coordinate_system to be described later. In a case that the flag is equal to false, the coordinate system for mesh displacements is not updated.

afve_subdivision_iteration_count: indicates the number of subdivision iterations of the mesh.

### Decoding and Derivation of Mesh-Level Coding Parameters

Mesh-level coding parameters to be decoded from coded data in the submesh information decoder 3024 will be described.

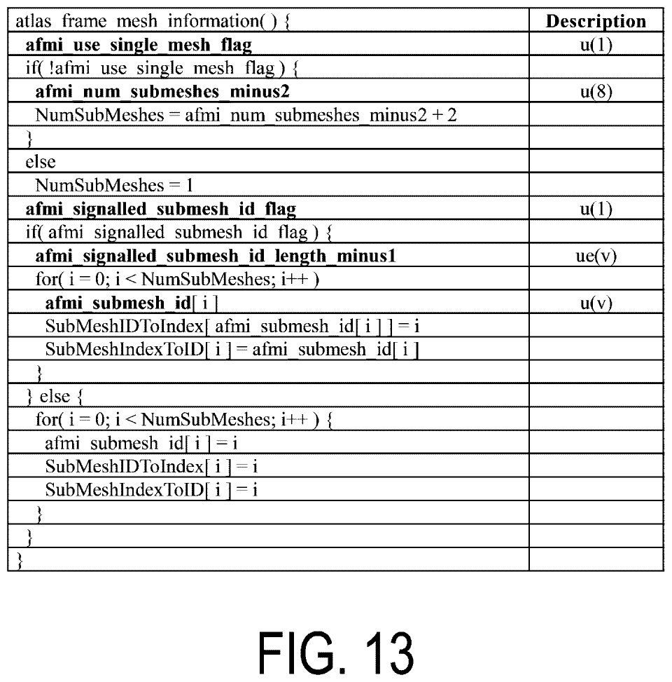

FIG. 13 is an example of a syntax structure of submesh information atlas_frame_mesh_information( ) to be transmitted in the AFPS. In the example of the syntax structure of FIG. 13, the number of submesh IDs is encoded and decoded regardless of the number of submeshes to be referred to. atlas_frame_mesh_information( ) may include one of the following syntax elements. Semantics of each field is as follows.

afmi_use_single_mesh_flag: flag indicating whether there is only one submesh or not (more than one submesh) to be referred to by a mesh patch in each atlas frame referring to the AFPS. In a case that the value is true, it indicates that there is only one submesh to be referred to. In a case that the value is false, it indicates that there are multiple submeshes (more than one submesh) to be referred to.

afmi_num_submeshes_minus2: parameter indicating the number of submeshes to be referred to by the mesh patch. In a case that the value of afmi_use_single_mesh_flag is true, the number of submeshes is 1. In a case that the value of afmi_use_single_mesh_flag is false, the number of submeshes is afmi_num_submeshes_minus2+2.

afmi_signalled_submesh_id_flag: flag indicating whether or not the submesh ID to be referred to by the mesh patch is signaled. In a case that the value is true, it indicates that the submesh ID is signaled. In a case that the value is false, it indicates that the submesh ID is not signaled.

afmi_signalled_submesh_id_length_minus1: value obtained by adding 1 to afmi_signalled_submesh_id_length_minus1 indicates the number of bits used to express a syntax element mdu_submesh_id[tileID][patchIdx] in meshpatch_data_unit( ) having an index of patchIdx and a syntax element afmi_submesh_id[i] in the current atlas tile whose tile ID is equal to tileID. The value of afmi_signalled_submesh_id_length_minus1 shall be within a range of 0 to 15. In a case of not being present, the value is inferred to be equal to Ceil(Log 2(NumSubMeshes))−1.

afmi_submesh_id[i]: parameter indicating the submesh ID of an i-th submesh. In a case that the value of afmi_signalled_submesh_id_flag is false, i.e., in a case that afmi_submesh_id[i] is not present, the value of afmi_submesh_id[i] is inferred to be equal to i for each i within a range of 0 to NumSubMeshes−1. afmi_submesh_id[i] not being equal to afmi_submesh_id[j] for all of i!=j is a bitstream conformance requirement. A variable FirstSubmeshID is derived as follows.

FirstSubmeshID = afmi_submesh_id[0]
for (i = 1; i < NumSubMeshes; i++)
FirstSubmeshID = Min(FirstSubmeshID, afmi_submesh_id[ i ])

The atlas information decoder 302 (submesh information decoder 3024) decodes frame mesh information from coded data of the AFPS of the atlas information. For example, afmi_use_single_mesh_flag, afmi_num_submeshes_minus2, afmi_signalled_submesh_id_flag, afmi_signalled_submesh_id_length_minus1, and afmi_submesh_id are decoded. The atlas information encoder 101 (submesh information encoder 1012) encodes frame mesh information into coded data of the AFPS of the atlas information.

In a case that afmi_signalled_submesh_id_flag is true, the submesh information decoder 3024 decodes afmi_submesh_id[i] as many as the number NumSubMeshes of submeshes within a range of i=0 . . . NumSubMeshes−1, and derives arrays SubMeshIDToIndex and SubMeshIndextoID regarding i=0 . . . NumSubMeshes−1 as follows.

$$SubMeshIDToIndex [ afmi\_submesh \_id [ i ] ] = i \\ SubMeshIndextoID [ i ] = afmi\_submesh \_id [ i ]$$

Note that, as in the syntax structure of FIG. 13, only in a case of if (!afmi_use_single_mesh_flag), afmi_signalled_submesh_id_flag, if (afmi_signalled_submesh_id_flag), and the following { } part may be present. Alternatively, in a case that the number NumSubmeshes of submeshes is greater than 1, the part may be present.

In other words, instead of

```
afmi_signalled_submesh_id_flag
if (afmi_signalled_submesh_id_flag || NumSubmeshes > 1) {
  ...
} else {
  ...
}
, the following may be used:
if (!afmi_use_single_mesh_flag) {
  afmi_signalled_submesh_id_flag
  if (afmi_signalled_submesh_id_flag) {
    ...
  } else {
    ...
  }
}
  .
```

In this case, in a case that afmi_use_single_mesh_flag is false (or the number NumSubmeshes of submeshes is greater than 1) and afmi_signalled_submesh_id_flag is true, the submesh information decoder 3024 may decode afmi_signalled_submesh_id_length_minus1 and afmi_submesh_id[i] as many as the number of submeshes minus 1 (NumSubMeshes−1) within a range of i=0 . . . NumSubMeshes−1. In a case that afmi_use_single_mesh_flag is true (or the number NumSubmeshes of submeshes is 1), the ID may be invariably 0 as in SubMeshIDToIndex[0]=0 and SubMeshIndexToID[0]=0.

In the syntax structure of FIG. 13, in a case that the value of afmi_use_single_mesh_flag is true, the ID may be invariably 0 as in SubMeshIDToIndex[0]=0 and SubMeshIndexToID[0]=0, with the value of afmi_signalled_submesh_id_flag being invariably false.

In a case that afmi_signalled_submesh_id_flag is true, the submesh information decoder 3024 derives the arrays regarding i=0 . . . NumSubMeshes−1 as follows, without decoding afmi_submesh_id[i].

$$SubMeshIDToIndex [ i ] = i$$

$$SubMeshIndextoID [ i ] =$$

### Operation of Mesh Patch Information Decoder

Here, patch-level coding parameters to be decoded from coded data in the patch information decoder 3025 will be described.

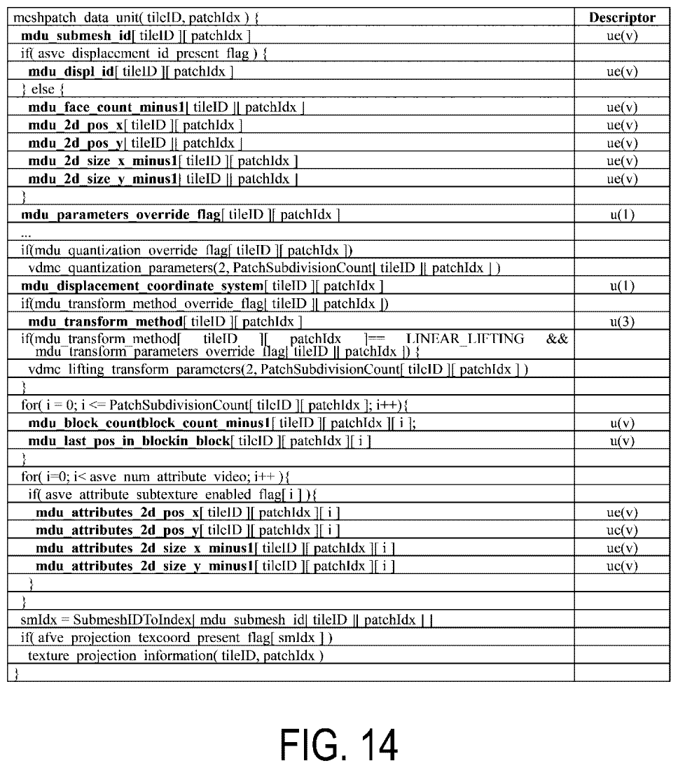

FIG. 14 is an example of syntax of mesh patch information in the AFPS being a picture/frame-level parameter set. Semantics of each field is as follows.

mdu_submesh_id[tileID][patchIdx]: indicates the submesh ID associated with the current mesh patch having the index patchIdx in the current atlas tile whose tile ID is equal to tileID. The value of mdu_submesh_id[tileID][patchIdx] shall be one of afmi_submesh_id[i].

mdu_displ_id[tileID][patchIdx]: indicates the mesh displacement ID associated with the current mesh patch having the index patchIdx in the current atlas tile having the tile ID equal to tileID. The value of mdu_disp_id[tileID][patchIdx] is within a range of 0 to 65535.

mdu_face_count_minus1[tileID][patchIdx]: indicates the number of planes associated with the current mesh patch having the index patchIdx in the atlas tile whose tile ID is equal to tileID.

mdu_2d_pos_x[tileID][patchIdx]: indicates the x-coordinate at the top left corner of a bounding box of the current mesh patch having the index patchIdx in the current atlas tile whose tile ID is equal to tileID, and is expressed as a multiple of PatchPackingBlockSize.

mdu_2d_pos_y[tileID][patchIdx]: indicates the y-coordinate at the top left corner of a bounding box of the current mesh patch having the index patchIdx in the current atlas tile whose tile ID is equal to tileID, and is expressed as a multiple of PatchPackingBlockSize.

mdu_2d_size_x_minus1[tileID][patchIdx]: value obtained by adding 1 to mdu_2d_size_x_minus1[tileID][patchIdx] indicates a value of the width of the bounding box of the current mesh patch of the mesh patch having the index patchIdx in the current atlas tile whose tile ID is equal to tileID.

mdu_2d_size_y_minus1[tileID][patchIdx]: value obtained by adding 1 to mdu_2d_size_y_minus1[tileID][patchIdx] indicates a value of the height of the bounding box of the current mesh patch of the mesh patch having the index patchIdx in the current atlas tile whose tile ID is equal to tileID.

mdu_displacement_coordinate_system[tileID][patchIdx]: indicates an identifier of the coordinate system of the submesh (part of the mesh) associated with the mesh patch having the index patchIdx in the current atlas tile whose tile ID is equal to tileID.

The mesh patch information decoder 3025 may decode tile-level mesh patch information as follows so that mesh reconstruction processing in the mesh reconstructor 307 can be performed by directly using tile information.

```
for( t = 0; t<= afti_num_tiles_in_atlas_frame_minus1; t++ ) {
  tileID = TileIndexToID( t )
  AtduTotalNumMeshpatches[ tileID ] = MaxNumMeshpatches
  for( p = 0; p <= AtduTotalNumMeshpatches[ tileID ]; p++ ) {
    TileMeshpatch2dPosX[ tileID ][ p ] =
      mdu_2d_pos_x[ tileID ][ p ] * PatchPackingBlockSize
    TileMeshpatch2dPosY[ tileID ][ p ] =
      mdu_2d_pos_y[ tileID ][ p ] * PatchPackingBlockSize
    TileMeshpatch2dSizeX[ tileID ][ p ] =
      (mdu_2d_size_x_minus1[ tileID ][ p ] + 1) * PatchSizeXQuantizer
    TileMeshpatch2dSizeY[ tileID ][ p ] =
      (mdu_2d_size_y_minus1[ tileID ][ p ] + 1) * PatchSizeYQuantizer
    for( attrIdx = 0; attrIdx < asve_num_attribute_video; attrIdx){
      TileMeshpatchAttributes2dPosX[ tileID ][ p ][ attrIdx ] =
        mdu_attributes_2d_pos_x[ tileID ][ p ][ attrIdx ]
      TileMeshpatchAttributes2dPosY[ tileID ][ p ][ attrIdx ] =
        mdu_attributes_2d_pos_y[ tileID ][ p ][ attrIdx ]
      TileMeshpatchAttributes2dSizeX[ tileID ][ p ][ attrIdx ] =
        (mdu_attributes_2d_size_x_minus1[ tileID ][ p ][ attrIdx ] + 1) *
          PatchSizeXQuantizer
      TileMeshpatchAttributes2dSizeY[ tileID ][ p ][ attrIdx ] =
        (mdu_attributes_2d_size_y_minus1[ tileID ][ p ][ attrIdx ] + 1) *
          PatchSizeYQuantizer
    }
    TileMeshpatchSubmeshID[ tileID ][ p ] = mdu_submesh_id[ tileID ][ p ]
    TileMeshpatchDisplID[ tileID ][ p ] = mdu_displ_id[ tileID ][ p ]
    TileMeshpatchSubdivCount[ tileID ][ p ] =
      PatchSubdivisionCount[ tileID ][ patchIdx ]
    for( i = 0; i < TileMeshpatchSubdivCount[ tileID ][ p ] ; i++ ){
      TileMeshpatchSubdivMethod[ tileID ][ p ][ i ] =
        PatchSubdivisionMethod[ tileID ][ p ][ i ]
    }
    TileMeshpatchDispCoordSys[ tileID ][ p ] =
      mdu_displacement_coordinate_system[ tileID ][ p ]
    TileMeshpatchTransformMethod[ tileID ][ p ] =
      mdu_transform_method[ tileID ][ p ]
    ...
  }
}
```

Here, in a case that the mesh reconstruction processing in the mesh reconstructor 307 is performed by using all the tile information, i.e., performed on an atlas basis, the tile-level mesh patch information may be transformed into atlas-level mesh patch information as follows.

```
AtlasTotalNumMeshpatches = 0
atlasPatchIdx = 0
for( t = 0; t <= afti_num_tiles_in_atlas_frame_minus1; t++ ) {
  tileID = TileIndexToID[ t ]
  tileOffsetX = TileOffsetX[ t ]
  tileOffsetY = TileOffsetY[ t ]
  for( p = 0; p < AtduTotalNumMeshpatches[ tileID ]; p++ ) {
    AtlasMeshpatch2dSizeX[ atlasPatchIdx ] =
      TileMeshpatch2dSizeX[ tileID ][ p ]
    AtlasMeshpatch2dSizeY[ atlasPatchIdx ] =
      TileMeshpatch2dSizeY[ tileID ][ p ]
    AtlasMeshpatch2dPosX[ atlasPatchIdx ] =
      TileMeshpatch2dPosX[ tileID ][ p ] + tileOffsetX
    AtlasMeshpatch2dPosY[ atlasPatchIdx ] =
      TileMeshpatch2dPosY[ tileID ][ p ] + tileOffsetY
    AtlasMeshpatchSubmeshID[ atlasPatchIdx ] =
      TileMeshpatchSubmeshID[ tileID ][ p ]
    AtlasMeshpatchDisplID[ atlasPatchIdx ] =
      TileMeshpatchDisplID[ tileID ][ p ]
    AtlasMeshpatchVertexCount[ atlasPatchIdx ] =
      TileMeshpatchVertexCount[ tileID ][ p ]
    AtlasMeshpatchFaceCount[ [ atlasPatchIdx ] =
      TileMeshpatchFaceCount[ tileID ][ p ] + 1
    AtlasMeshpatchSubdivCount[ atlasPatchIdx ] =
      TileMeshpatchSubdivCount[ tileID ][ p ]
    for( i = 0; i < AtlasMeshpatchSubdivCount[ atlasPatchIdx ]; i++ ){
      AtlasMeshpatchSubdivMethod[ atlasPatchIdx ][ i ] =
        TileMeshpatchSubdivMethod[ tileID ][ p ][ i ]
    }
    AtlasMeshpatchDispCoordSys[ atlasPatchIdx ] =
      TileMeshpatchDispCoordSys[ tileID ][ p ]
    AtlasMeshpatchTransformMethod[ atlasPatchIdx ] =
      TileMeshpatchTransformMethod[ tileID ][ p ]
    for( i=0; i<= AtlasPatchSubdivisionCount[ atlasPatchIdx ]; i++){
      AtlasPatchVertexBlockCount[ atlasPatchIdx ][ i ] =
        TilePatchVertexBlockCount[ tileID ][ p ][ i ]
      AtlasPatchVertexCountLast[ atlasPatchIdx ][ i ] =
        TilePatchVertexCountLast[ tileID ][ p ][ i ]
      AtlasPatchVertexCount[ atlasPatchIdx ][ i ] =
        TileVertexCount[ tileID ][ p ][ i ]
      AtlasPatchTotalVertexCount[ atlasPatchIdx ] =
        TilePatchTotalVertexCount[ tileID ][ p ]
    }
    if( asve_num_attribute_video > 0 ){
      AttributeTileMeshpatchParamsToAtlas( atlasPatchIdx, t, p )
    }
    AtlasMeshpatchTexcoordProjectionFlag[ atlasPatchIdx ] =
      TileMeshpatchTexcoordProjectionFlag[ tileID ][ p ]
    AtlasMeshpatchTexcoordProjectionWidthNormalization[ atlasPatchIdx ] =
      TileMeshpatchTexcoordProjectionWidthNormalization[ tileID ][ p ]
    AtlasMeshpatchTexcoordProjectionHeightNormalization[ atlasPatchIdx ] =
      TileMeshpatchTexcoordProjectionHeightNormalization[ tileID ][ p ]
    AtlasMeshpatchTexcoordProjectionGutter[ atlasPatchIdx ] =
      TileMeshpatchTexcoordProjectionGutter[ tileID ][ p ]
    if( AtlasMeshpatchTexcoordProjectionFlag[ atlasPatchIdx ] )
      SubpatchTileParamToAtlas( atlasPatchIdx, tileID, p )
    atlasPatchIdx += 1
  }
}
AtlasTotalNumMeshpatches = atlasPatchId
```

### Operation of Tile-Based Submesh Information Decoder and Mesh Patch Information Decoder

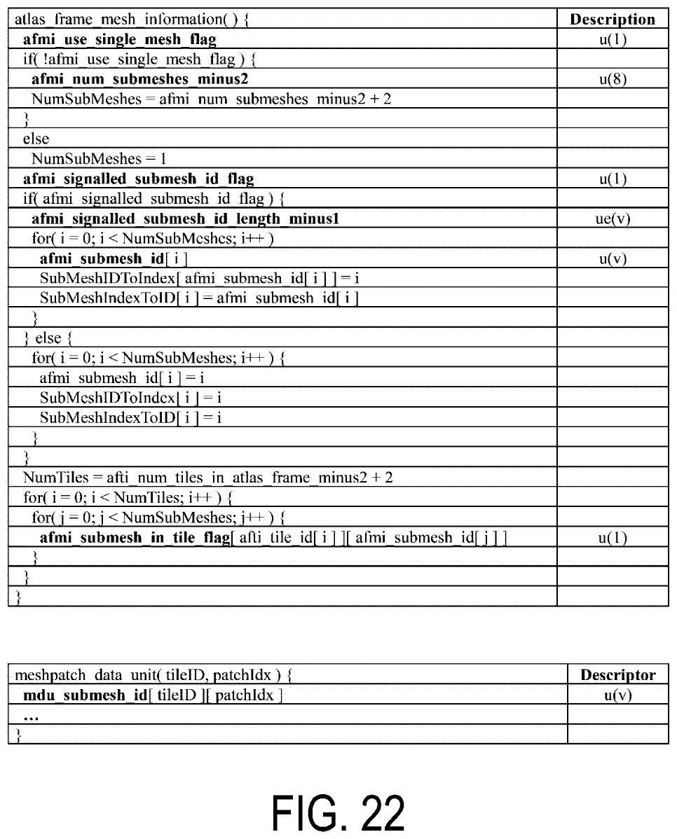

FIG. 22 is an example of syntax of mesh/submesh information.

As illustrated in the syntax structure of FIG. 22, the submesh information decoder 3024 loops at index i of a tile and index j of a submesh, and decodes a flag afmi_submesh_in_tile_flag[tileID][submeshID] (here, tileID=afti_tile_id[i], submeshID=afmi_submesh_id[j]) indicating whether or not tile information having a tile ID (tileID) of the tile of index i includes submesh information having a submesh ID (submeshID) of the submesh of index j. Semantics may be as follows.

afmi_submesh_in_tile_flag[tileID][submeshID]: indicates whether or not the tile information having the tile ID of the tile of index i includes the submesh information having the submesh ID of the submesh of index j. In a case that the flag has a value of true (for example, 1), it indicates that the tile information having the tile ID (afti_tile_id[i]) of the tile of index i includes the submesh information having the submesh ID (afmi_submesh_id[j]) of the submesh of index j, and in a case that the flag has a value of false (for example, 0), it indicates that the tile information having the tile ID (afti_tile_id[i]) of the tile of index i does not include the submesh information having the submesh ID (afmi_submesh_id[j]) of the submesh of index j.

Here, the tile information having the tile ID of the tile of index i including the submesh information having the submesh ID of the submesh of index j means correspondence between the tile and the mesh patch data decoded by using the parameters decoded from the tile information having the tile ID of the tile of index i and the submesh having the submesh ID of the submesh of index j that can be reconstructed. No inclusion means that there is no correspondence between decoding of the tile having the tile ID of the tile of index i and reconstruction of the submesh having the submesh ID of the submesh of index j.

Here, regarding the two-dimensional array afmi_submesh_in_tile_flag[afti_tile_id[i]][afmi_submesh_id[j]], the submesh information having the submesh ID (afmi_submesh_id[j]) of index j being included in only one piece of tile information of index i and not to be included in other pieces of tile information (exclusive restriction) may be a conformance requirement. In other words, as in the example below, multiple pieces of tile information shall not include submesh information having the same submesh ID.

$$afmi\_submesh \_in \_tile \_flag [ afti\_tile \_id [ 0 ] ] [ afmi\_submesh \_id [ 0 ] ] = 0 \\ afmi\_submesh \_in \_tile \_flag [ afti\_tile \_id [ 0 ] ] [ afmi\_submesh \_id [ 1 ] ] = 1 \\ afmi\_submesh \_in \_tile \_flag [ afti\_tile \_id [ 0 ] ] [ afmi\_submesh \_id [ 2 ] ] = 1 \\ afmi\_submesh \_in \_tile \_flag [ afti\_tile \_id [ 1 ] ] [ afmi\_submesh \_id [ 0 ] ] = 1 \\ afmi\_submesh \_in \_tile \_flag [ afti\_tile \_id [ 1 ] ] [ afmi\_submesh \_id [ 1 ] ] = 1 \\ afmi\_submesh \_in \_tile \_flag [ afti\_tile \_id [ 1 ] ] [ afmi\_submesh \_id [ 2 ] ] = 0$$

In the example, the tile information having tile IDs of the tiles of indices 0 and 1 includes the submesh information having the submesh ID of the submesh of index 1, and thus this violates the conformance requirement.

Here, regarding the two-dimensional array afmi_submesh_in_tile_flag[afti_tile_id[i]][afmi_submesh_id[j]], in a case that multiple pieces of submesh information include the tile information having the tile ID (afti_tile_id[i]) of index i, a restriction that indices SubMeshIDToIndex[aftmi_submesh_id[j]] of the submesh information need to be consecutive indices such as 0, 1, and 2 and the submesh information of non-consecutive indices such as 1, 3, and 5 and 1, 2, and 4 does not include (shall not include) the same tile information may be a conformance requirement.

In the syntax structure of FIG. 22, the number NumTiles of tiles may be derived as NumTiles=afti_num_tiles_in_atlas_frame_minus2+2 by decoding afti_num_tiles_in_atlas_frame_minus2. Alternatively, it may be derived as NumTiles=afti_num_tiles_in_atlas_frame_minus1+1 by decoding afti_num_tiles_in_atlas_frame_minus1. Here, in a case that the value of the syntax element afti_single_tile_in_atlas_frame_flag or the syntax element afti_single_partition_per_tile_flag of aflas_frame_tile_information( ) is false (for example, 0), the number of tiles is derived as NumTiles=1.

Here, in a case that numTiles=2, numSubMeshes=3, and afmi_signalled_submesh_id_flag=0, examples of values of afmi_submesh_in_tile_flag[afti_tile_id[i]][afmi_submesh_id[j]] in a case that afti_tile_id[0] includes afmi_submehs_id[1] and afmi_submesh_id[2] and afti_tile_id[1] includes afmi_submesh_id[0] are illustrated.

$$afmi\_submesh \_in \_tile \_flag [ 0 ] [ 0 ] = 0 \\ afmi\_submesh \_in \_tile \_flag [ 0 ] [ 1 ] = 1 \\ afmi\_submesh \_in \_tile \_flag [ 0 ] [ 2 ] = 1 \\ afmi\_submesh \_in \_tile \_flag [ 1 ] [ 0 ] = 1 \\ afmi\_submesh \_in \_tile \_flag [ 1 ] [ 1 ] = 0 \\ afmi\_submesh \_in \_tile \_flag [ 1 ] [ 2 ] = 0$$

Here, the mesh patch information decoder 3025 derives the tile-level mesh patch information as follows.

```
for ( t = 0; t <= afti_num_tiles_in_atlas_frame_minus1; t++ ) {
  tileID = TileIndexToID[ t ]
  AtduTotalNumMeshpatches[ tileID ] = MaxNumMeshpatches
  for( si = 0; si < afmi_num_submeshes_minus2 + 2; si++ ) {
    submeshID = SubMeshIndexToID[ si ]
    if( afmi_submesh_in_tile_flag[ tileID ][ submeshID ] ) {
      for( p = 0; p <= AtduTotalNumMeshpatches[ tileID ]; p++ ) {
        if( submeshID == mdu_submesh_id[ tileID ][ p ] ) {
          ...
          TileMeshpatchSubmeshID[ tileID ][ p ] = submeshID
          ...
        }
      }
    }
  }
}
```

The mesh patch information decoder 3025 may derive the mesh patch information corresponding to tile-level submeshes as follows.

```
for( t = 0; t <= afti_num_tiles_in_atlas_frame_minus1; t++ ) {
  tileID = TileIndexToID[ t ]
  for( si = 0; si < afmi_num_submeshes_minus2 + 2; si++ ) {
    submeshID = SubMeshIndexToID[ si ]
    if( afmi_submesh_in_tile_flag[ tileID ][ submeshID ] ) {
      AtduTotalNumMeshpatches[ tileID ][ submeshID ] = MaxNumMeshpatches
      for( p = 0; p <= AtduTotalNumMeshpatches[ tileID ][ submeshID ]; p++ ){
        TileMeshpatch2dPosX[ tileID ][ submeshID ][ p ] =
          mdu_2d_pos_x[ tileID ][ submeshID ][ p ] * PatchPackingBlockSize
        TileMeshpatch2dPosY[ tileID ][ submeshID ][ p ] =
          mdu_2d_pos_y[ tileID ][ submeshID ][ p ] * PatchPackingBlockSize
        TileMeshpatch2dSizeX[ tileID ][ submeshID ][ p ] =
          (mdu_2d_size_x_minus1[ tileID ][ submeshID ][ p ] + 1) *
            P PatchSizeXQuantizer
        TileMeshpatch2dSizeY[ tileID ][ submeshID ][ p ] =
          (mdu_2d_size_y_minus1[ tileID ][ submeshID ][ p ] + 1) *
            PatchSizeYQuantizer
        for( attrIdx = 0; attrIdx < asve_num_attribute_video; attrIdx){
          TileMeshpatchAttributes2dPosX[tileID][submeshID][p][attrIdx] =
            mdu_attributes_2d_pos_x[ tileID ][ submeshID ][ p ][ attrIdx ]
          TileMeshpatchAttributes2dPosY[tileID][submeshID][p][attrIdx] =
            mdu_attributes_2d_pos_y[ tileID ][ submeshID ][ p ][ attrIdx ]
          TileMeshpatchAttributes2dSizeX[tileID][submeshID][p][attrIdx] =
            (mdu_attributes_2d_size_x_minus1[tileID][submeshID][p][attrIdx] +
              1) * PatchSizeXQuantizer
          TileMeshpatchAttributes2dSizeY[tileID][submeshID][p][attrIdx] =
            (mdu_attributes_2d_size_y_minus1[tileID][submeshID][p][attrIdx] +
              1) * PatchSizeYQuantizer
        }
        TileMeshpatchSubmeshID[ tileID ][ submeshID ][ p ] = submeshID
        TileMeshpatchDisplID[ tileID ][ submeshID ][ p ] =
          mdu_displ_id[ tileID ][ submeshID ][ p ]
        TileMeshpatchSubdivCount[ tileID ][ submeshID ][ p ] =
          PatchSubdivisionCount[ tileID ][ patchIdx ]
        for( i = 0; i<TileMeshpatchSubdivCount[tileID][submeshID][p] ; i++ ){
          TileMeshpatchSubdivMe|thod[ tileID ][ submeshID ][ p ][ i ] =
            PatchSubdivisionMethod[ tileID ][ submeshID ][ p ][ i ]
        }
        TileMeshpatchDispCoordSys[ tileID ][ submeshID ][ p ] =
          mdu_displacement_coordinate_system[ tileID ][ submeshID ][ p ]
        TileMeshpatchTransformMethod[ tileID ][ submeshID ][ p ] =
          mdu_transform_method[ tileID ][ submeshID ][ p ]
        ...
      }
    }
  }
}
```

Here, the tile-level mesh patch information may be transformed into atlas-level mesh patch information as follows.

```
AtlasTotalNumMeshpatches = 0
atlasPatchIdx = 0
for( t = 0; t <= afti_num_tiles_in_atlas_frame_minus1; t++ ) {
  tileID = TileIndexToID[ t ]
  tileOffsetX = TileOffsetX[ t ]
  tileOffsetY = TileOffsetY[ t ]
  for( si = 0; si < afmi_num_submeshes_minus2 + 2; si++ ) {
    submeshID = SubMeshIndexToID[ si ]
    if( afmi_submesh_in_tile_flag[ tileID ][ submeshID ] ) {
      for( p = 0; p < AtduTotalNumMeshpatches[ tileID ][ submeshID ]; p++ ) {
        AtlasMeshpatch2dSizeX[ atlasPatchIdx ] =
          TileMeshpatch2dSizeX[ tileID ][ submeshID ][ p ]
        ...
        atlasPatchIdx += 1
      }
    }
  }
}
AtlasTotalNumMeshpatches = atlasPatchIdx
```

Here, TileIndexToID[i] is a table for deriving the tile ID (tileID) from index i.

Here, the syntax element afmi_submesh_in_tile_flag may be encoded and decoded by using an index tileIndex derived from the tile ID and an index submeshIndex derived from the submesh ID as follows.

```
atlas_frame_mesh_information( ) {
  ...
  for( i = 0; i < NumTiles; i++ ) {
    for( j = 0; j < NumSubMeshes; j++ ) {
      tileIndex = TileIDToIndex[ afti_tile_id[ i ] ]
      submeshIndex = SubMeshIDToIndex[ afmi_submesh_id[ j ] ]
      afmi_submesh_in_tile_flag[ tileIndex ][ submeshIndex ]
    }
  }
  ...
}
```

The syntax element afmi_submesh_in_tile_flag[i][j] may be encoded and decoded by using indices i and j without using IDs of the syntax elements afti_tile_id[i] and afmi_submesh_id[j] as follows.

```
atlas_frame_mesh_information( ) {
  ...
  for( i = 0; i < NumTiles; i++ ) {
    for( j = 0; j < NumSubMeshes; j++ ) {
      afmi_submesh_in_tile_flag[ i ][ j ]
    }
  }
  ...
}
```

Here, the tile ID of the tile of index i can be derived from TileIndexToID[i], and the submesh ID of the submesh of index j can be derived from SubMeshIndexToID[j].

According to the configuration described above, coded data can derive correspondence between the tile information and the submesh information, the tile information and the mesh patch information, and the submesh information and the mesh patch information on a tile basis by using a flag indicating whether or not the tile information having any tile ID decoded in the submesh information decoder and the submesh information having any submesh ID have correspondence. Therefore, there is an effect that, by identifying the tile information and the mesh patch information corresponding to any submesh, only the tile information and the mesh patch information necessary for reconstruction of any submesh can be decoded.

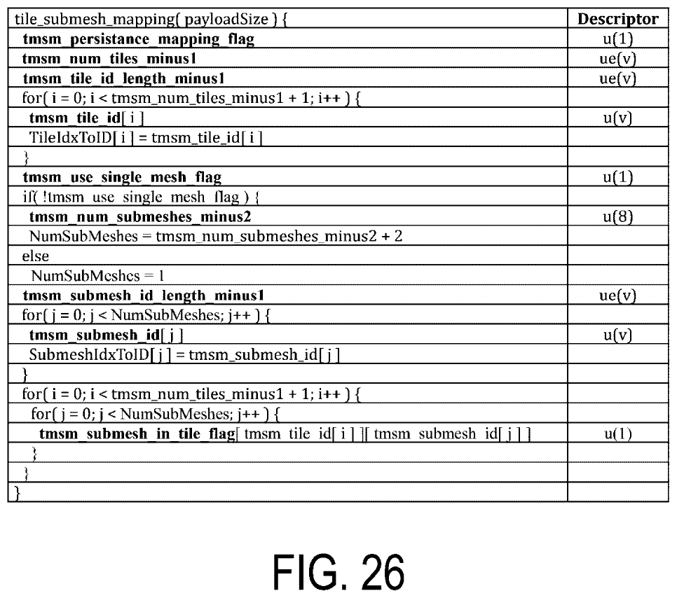

As illustrated in the syntax structure of FIG. 26, there may be a loop at index i of a tile and index j of a submesh, and a flag tmsm_submesh_in_tile_flag[tmsm_tile_id[i]][tmsm_submesh_id[j]] indicating whether or not the tile information having the tile ID of the tile of index i includes the submesh information having the submesh ID of the submesh of index j may be transmitted using SEI. The following example may be used for semantics.

tmsm_persistance_mapping_flag: in a case that the value of tmsm_persistance_mapping_flag is equal to 1, it indicates that tile/submesh mapping is persistent. In a case that the flag is equal to 0, it indicates that tile/submesh mapping is valid only for the current frame.

tmsm_num_tiles_minus1: indicates the number of tiles tmsm_num_tiles_minus1+1 present in a coded atlas sequence (CAS). tmsm_num_tiles_minus1 is equal to afti_num_tiles_in_atlas_frame_minus1.

tmsm_tile_id_length_minus1: in a case that a syntax element tmsm_tile_id[i] is present, a value obtained by adding 1 to tmsm_tile_id_length_minus1 indicates the number of bits used to express the syntax element. The value of tmsm_tile_id_length_minus1 is within a range of 0 to 15.

tmsm_tile_id[i]: indicates the tile ID of an i-th tile. In a case that tmsm_tile_id[i] is not present, the value of tmsm_tile_id[i] is inferred to be equal to i regarding each i within a range of 0 to tmsm_num_tiles_minus1 including tmsm_num_tiles_minus1. tmsm_tile_id[i] not being equal to tmsm_tile_id[k] for all of i!=k is a bitstream conformance requirement.

tmsm_use_single_mesh_flag: in a case that the flag is equal to 1, it indicates that only one submesh is present. In a case that tmsm_use_single_mesh_flag is equal to 0, it indicates that multiple submeshes are present.

tmsm_num_submeshes_minus2: value obtained by adding 2 to tmsm_num_submeshes_minus2 indicates the number NumSubMeshes of submeshes present. In a case that tmsm_num_submeshes_minus2 is not present, and tmsm_use_single_mesh_flag is equal to 1, the value of NumSubMeshes is inferred to be equal to 1.

tmsm_submesh_id_length_minus1: value obtained by adding 1 to tmsm_submesh_id_length_minus1 indicates the number of bits used to express the syntax element tmsm_submesh_id[j]. The value of tmsm_signalled_submesh_id_length_minus1 is within a range of 0 to 15. In a case of not being present, the value is inferred to be equal to Ceil(Log 2(NumSubMeshes)−1).

tmsm_submesh_id[j]: indicates the submesh ID of a j-th submesh. In a case of not being present, the value of tmsm_submesh_id[j] is inferred to be equal to j for each j within a range of 0 to NumSubMeshes−1. The length of tmsm_submesh_id[j] is tmsm_submesh_id_length_minus1+1 bits.

tmsm_submesh_in_tile_flag[tmsm_tile_id[i]][tmsm_submesh_id[j]]: indicates whether or not the tile information having the tile ID of the tile of index i includes the submesh information having the submesh ID of the submesh of index j. In a case that the flag has a value of true (for example, 1), it indicates that the tile information having the tile ID (tmsm_tile_id[i]) of the tile of index i includes the submesh information having the submesh ID (tmsm_submesh_id[j]) of the submesh of index j, and in a case that the flag has a value of false (for example, 0), it indicates that the tile information having the tile ID (tmsm_tile_id[i]) of the tile of index i does not include the submesh information having the submesh ID (tmsm_submesh_id[j]) of the submesh of index j.

Here, the mesh patch information decoder 3025 may derive the tile-level mesh patch information by using the syntax element tmsm_submesh_in_tile_flag[tmsm_tile_id[i]][tmsm_submesh_id[j]].

In another configuration, the syntax element tmsm_submesh_in_tile_flag[i][j] may be encoded and decoded by using indices such as i and j without using IDs of the syntax elements tmsm_tile_id[i] and tmsm_submesh_id[j] as follows.

```
tile_submesh_mapping( payloadSize ) {
  ...
  for( i = 0; i < tmsm_num_tiles_minus1 + 1; i++ ) {
    for( j = 0; j < NumSubMeshes; j++ ) {
      tmsm_submesh_in_tile_flag[ i ][ j ]
    }
  }
  ...
}
```

Here, the tile ID of the tile of index i can be derived from TileldxToID[i], and the submesh ID of the submesh of index j can be derived from SubmeshIdxToID[j].

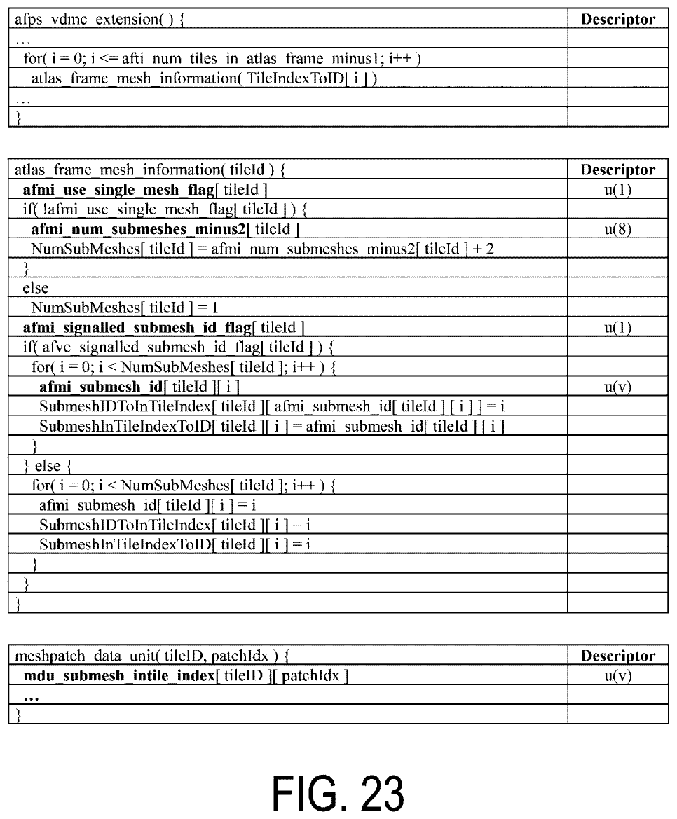

FIG. 23 is an example of syntax of mesh/submesh information.

In another configuration, as illustrated in the syntax structure of FIG. 23, the submesh information decoder 3024 may decode the flag afmi_use_single_mesh_flag[tileId] indicating whether or not the number of pieces of submesh information having the submesh ID included in the tile is one, and in a case that the value of afmi_use_single_mesh_flag[tileId] is false, the submesh information decoder 3024 may decode a syntax element indicating the number NumSubMeshes of submeshes having the submesh ID included in the tile as afmi_num_submeshes_minus2[tileId], and derive NumSubMeshes=afmi_num_submeshes_minus2[tileId]+2. In a case that the value of afmi_use_single_mesh_flag[tileId] is true, and afmi_num_submeshes_minus2[tileId] is not present, NumSubMeshes=1 is inferred. As illustrated in FIG. 23, in a case that the value of afmi_signalled_submesh_id_flag[tileId] is true, the submesh information decoder 3024 may decode submesh IDs (afmi_submesh_id[tileId][j]) of one or more j included in tile information of certain i as the submesh information. Two-dimensional arrays with indices of tileId and the submesh IDs (afmi_submesh_id[tileId][j]) may be derived for the decoded tile ID and submesh ID. The two-dimensional arrays indicating the correspondence between the submeshes and the tile may be SubmeshIDToInTileIndex and SubmeshInTileIndexToID. In a case that afmi_signalled_submesh_id_flag[tileId] is true, afmi_submesh_id[tileId][j] as many as the number NumSubMeshes of submeshes included in the tile within a range of j=0 . . . NumSubMeshes−1 is decoded, and arrays SubmeshIDToInTileIndex and SubmeshInTileIndexToID are derived regarding i=0 . . . NumSubMeshes−1 as follows.

$$SubmeshIDToInTileIndex [ tileId ] [ afmi\_submesh \_id [ tileId ] [ j ] ] = j \\ SubmeshInTileIndexToID [ tileId ] [ j ] = afmi\_submesh \_id [ tileId ] [ j ]$$

Here, the following example may be used for semantics.

afmi_submesh_id[tileID][i]: indicates the submesh ID of an i-th submesh of the tile whose tile ID is equal to tileID. In a case of not being present, the value of afmi_submesh_id[tileID][i] is inferred to be equal to i for each i within a range of 0 to NumSubMeshes[tileId]. The length of the syntax element of afmi_submesh_id[i] is asve_signalled_submesh_id_length_minus1+1 bits. afmi_submesh_id[tileId][i] being present in a base mesh sub-bitstream is a requirement.

mdu_submesh_intile_index[tileID][patchIdx]: indicates a submesh index associated with the current patch having the index patchIdx in the current atlas tile having the tile ID equal to tileID. The value of mdu_submesh_intile_index[tileID][patchIdx] shall be within a range of 0 to NumSubMeshes[tileId]. The length of the syntax element of mdu_submesh_intile_index[tileID][patchIdx] is Ceil(Log 2(NumSubMeshes[tileID]))−1 bits. In a case that mdu_submesh_intile_index[tileID][patchIdx] is not present, mdu_submesh_intile_index[tileID][patchIdx] is derived as patchIdx.

In a case that the value of afmi_signalled_submesh_id_flag[tileId] is invariably false, as another example, as in the following syntax structure, the value of afmi_submesh_id[tileId][j] may be derived.

for(j = 0; j < NumSubMeshes; j++) {
afmi_submesh_id[ tileId ][ j ]= j
}

Here, the mesh patch information decoder 3025 derives the tile-level mesh patch submesh ID (TileMeshpatchSubmeshID) as follows.

$$TileMeshpatchSubmeshID [ tileID ] [ p ] = afmi\_submesh \_id [ tileID ] [ mdu\_submesh \_intile \_index [ tileID ] [ p ] ]$$

According to the configuration described above, coded data can derive correspondence between the tile information and the submesh information, the tile information and the mesh patch information, and the submesh information and the mesh patch information on a tile basis by using the tile information having any tile ID decoded in the mesh patch information decoder and the index of the submesh information corresponding to the mesh patch having a certain patch index. Therefore, there is an effect that, by identifying the tile information and the mesh patch information corresponding to any submesh, only the tile information and the mesh patch information necessary for reconstruction of any submesh can be decoded.

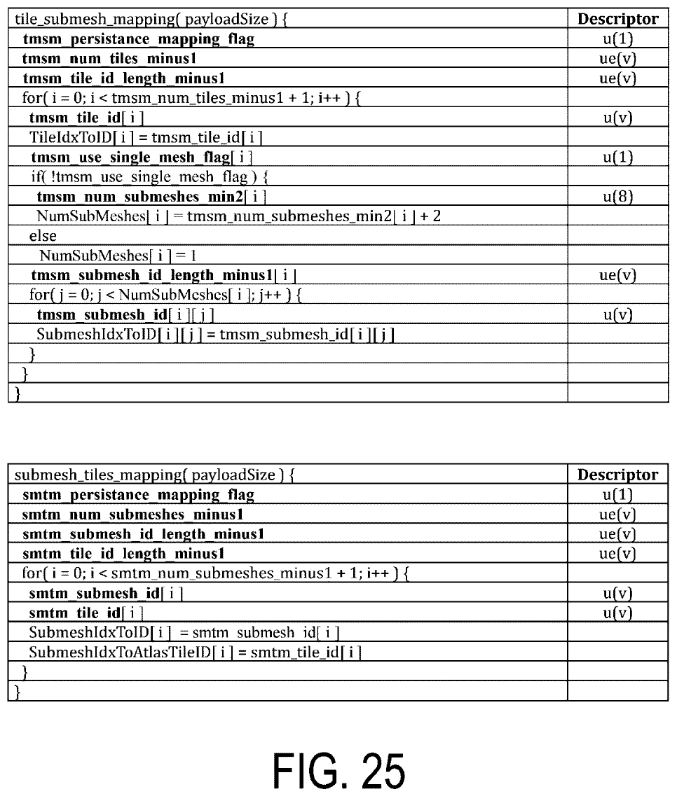

As illustrated in the syntax structure of FIG. 25, the flag tmsm_use_single_mesh_flag[i] indicating whether or not the number of pieces of submesh information having the submesh ID included in the tile is one may be decoded, and in a case that the value of tmsm_use_single_mesh_flag[i] is false, the syntax element tmsm_num_submeshes_minus2[i] indicating the number NumSubMeshes of submeshes having the submesh ID included in the tile may be decoded, and NumSubMeshes=afmi_num_submeshes_minus2[tileId]+2 may be derived and transmitted using SEI. smtm_num_submeshes_minus1 indicating the number of submeshes associated with the tile may be decoded, the tile ID (smtm_tile_id[i]) associated with each submesh ID (smtm_submesh_id[i]) may be decoded, and SubmeshIdxToID[i] and SubmeshIdxToAtlasTileID[i] may be derived and transmitted using SEI. The following example may be used for semantics.

smtm_persistance_mapping_flag: in a case that the flag is equal to 1, it indicates that submesh tile mapping is persistent. In a case that the flag is equal to 0, it indicates that submesh tile mapping is valid only for the current frame.

smtm_num_submeshes_minus1: indicates the number of submeshes smtm_num_submeshes_minus1+1 associated with the tile present in a CAS.

smtm_submesh_id_length_minus1: in a case that a syntax element smtm_submesh_id[i] is present, a value obtained by adding 1 to smtm_submesh_id_length_minus1 indicates the number of bits used to express the syntax element.

smtm_tile_id_length_minus1: in a case that a syntax element smtm_tile_id[i] is present, a value obtained by adding 1 to smtm_tile_id_length_minus1 indicates the number of bits used to express smtm_tile_id[i].

smtm_submesh_id[i]: indicates an i-th submesh ID. smtm_submesh_id[i] not to be equal to smtm_submesh_id[k] for all of i!=k is a bitstream conformance requirement.

smtm_tile_id[i]: indicates the tile ID associated with the submesh of index i.

Here, the mesh patch information decoder 3025 may derive the tile-level mesh patch submesh ID (TileMeshpatchSubmeshID) as follows.

$$TileMeshpatchSubmeshID [ tileID ] [ p ] = tmsm\_submesh \_id [ tile ID ] [ mdu\_submesh \_intile \_index [ tileID ] [ p ] ]$$

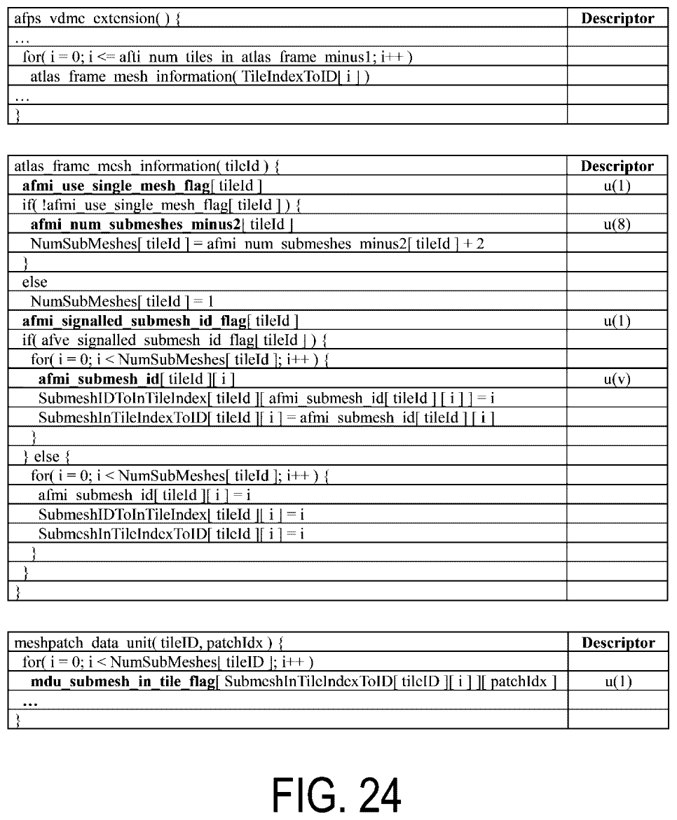

In another configuration, as illustrated in the syntax structure of the mesh/submesh information of FIG. 24, a flag mdu_submesh_in_tile_flag[SubmeshInTileIndexToID[tileID][i]][patchIdx] indicating correspondence between the submesh information having the submesh ID of index i corresponding to the tile information having the tile ID of the tile of index tileID and the mesh patch having the index patchIdx is decoded, and in a case that the submesh information whose submesh ID is equal to SubmeshInTileIndexToID[tileID][i] and the mesh patch having the patch index patchIdx have correspondence, mdu_submesh_in_tile_flag[SubmeshInTileIndexToID[tileID][i]][patchIdx] is decoded as a value (for example, 1) indicating that there is correspondence. In a case that the submesh information whose submesh ID is equal to SubmeshInTileIndexToID[tileID][i] and the mesh patch having the patch index patchIdx do not have correspondence, mdu_submesh_in_tile_flag[SubmeshInTileIndexToID[tileID][i]][patchIdx] is decoded as a value (for example, 0) indicating that there is no correspondence. Although there may be multiple mesh patches corresponding to the submesh information whose submesh ID is equal to SubmeshInTileIndexToID[tileID][i], the number of pieces of submesh information to which the mesh patch having the patch index patchIdx corresponds shall be one. The following example may be used for semantics.

mdu_submesh_in_tile_flag[SubmeshInTileIndexToID[tileID][i]][patchIdx]: indicates whether or not the submesh information whose submesh ID is equal to SubmeshInTileIndexToID[tileID][i] and the mesh patch having the patch index patchIdx have correspondence. In a case that the flag has a value of 1, it indicates that the submesh information whose submesh ID is equal to SubmeshInTileIndexToID[tileID][i] and the mesh patch having the patch index patchIdx have correspondence, and in a case that the flag has a value of 0, it indicates that the submesh information whose submesh ID is equal to SubmeshInTileIndexToID[tileID][i] and the mesh patch having the patch index patchIdx do not have correspondence.

Here, the mesh patch information decoder 3025 derives the tile-level mesh patch information as follows.

```
for( t = 0; t <= afti_num_tiles_in_atlas_frame_minus1; t++ ) {
  tileID = TileIndexToID[ t ]
  AtduTotalNumMeshpatches[ tileID ] = MaxNumMeshpatches
  for( si = 0; si < afmi_num_submeshes_minus2[ tileID ] + 2; si++ ) {
    submeshID = SubmeshInTileIndexToID[ tileID ][ si ]
    for( p = 0; p <= AtduTotalNumMeshpatches[ tileID ]; p++ ) {
      if( mdu_submesh_in_tile_flag[ submeshID ] ][ p ] ) {
        ...
        TileMeshpatchSubmeshID[ tileID ][ p ] = submeshID
        ...
      }
    }
  }
}
```

According to the configuration described above, coded data can derive correspondence between the tile information and the submesh information, the tile information and the mesh patch information, and the submesh information and the mesh patch information on a tile basis by using a flag indicating whether or not the submesh information having any submesh ID decoded in the mesh patch information decoder and the mesh patch having a certain patch index have correspondence. Therefore, there is an effect that, by identifying the tile information and the mesh patch information corresponding to any submesh, only the tile information and the mesh patch information necessary for reconstruction of any submesh can be decoded.

### Operation of Submesh-Based Submesh Information Decoder and Mesh Patch Information Decoder

In another configuration, as in the following syntax structure, there may be a loop in units of index i of a submesh and index j of a tile, and a flag afmi_tile_in_submesh_flag[submeshID][tileID] (here, submeshID=afmi_submesh_id[i], tileID=afti_tile_id[j]) indicating whether or not the submesh having the submesh ID (submeshID) includes the tile having the tile ID (tileID) of the tile of index j may be decoded. Here, the submesh information having the submesh ID of the submesh of index i including the tile information having the tile ID of the tile of index j means that the tile and the mesh patch data need to be decoded by using the parameters decoded from the tile information having the tile ID of the tile of index j in a case that the submesh having the submesh ID of index i is reconstructed. No inclusion means that there is no correspondence between reconstruction of the submesh having the submesh ID of index i and decoding of the tile having the tile ID of the tile of index j.

```
atlas_frame_mesh_information( ) {
  ...
  for( i = 0; i < NumSubMeshes; i++ ) {
    for( j = 0; j < NumTiles; j++ ) {
      afmi_tile_in_submesh_flag[ afmi_submesh_id[ i ] ][ afti_tile_id[ j ] ]
    }
  }
  ...
}
```

Here, the following example may be used for semantics.

afmi_tile_in_submesh_flag[afmi_submesh_id[i]][afti_tile_id[j]]: indicates whether or not the submesh information having the submesh ID of the submesh of index i includes the tile information having the tile ID of the tile of index j. In a case that the flag has a value of 1, it indicates that the submesh information having the submesh ID (afmi_submesh_id[i]) of the submesh of index i includes the tile information having the tile ID (afti_tile_id[j]) of the tile of index j, and in a case that the flag has a value of 0, it indicates that the submesh information having the submesh ID (afmi_submesh_id[i]) of the submesh of index i does not include the tile information having the tile ID (afti_tile_id[j]) of the tile of index j.

Here, regarding the two-dimensional array afmi_tile_in_submesh_flag[submeshID][tileID], the tile information having the tile ID (afmi_tile_id[j]) of the tile of index j being included in only one piece of submesh information and not being included in other pieces of submesh information (exclusive restriction) may be a conformance requirement. In other words, as in the example below, multiple pieces of submesh information shall not include tile information having the same tile ID.

$$afmi\_tile \_in \_submesh \_flag [ afti\_tile \_id [ 0 ] ] [ afmi\_tile \_id [ 0 ] ] = 0 \\ afmi\_tile \_in \_submesh \_flag [ afti\_tile \_id [ 0 ] ] [ afmi\_tile \_id [ 1 ] ] = 1 \\ afmi\_tile \_in \_submesh \_flag [ afti\_tile \_id [ 0 ] ] [ afmi\_tile \_id [ 2 ] ] = 1 \\ afmi\_tile \_in \_submesh \_flag [ afti\_tile \_id [ 1 ] ] [ afmi\_tile \_id [ 0 ] ] = 1 \\ afmi\_tile \_in \_submesh \_flag [ afti\_tile \_id [ 1 ] ] [ afmi\_tile \_id [ 1 ] ] = 1 \\ afmi\_tile \_in \_submesh \_flag [ afti\_tile \_id [ 1 ] ] [ afmi\_tile \_id [ 2 ] ] = 0$$

In the example, the submesh information having submesh IDs of the submeshes of indices 0 and 1 includes the tile information having the tile ID of the tile of index 1, and thus this violates the conformance requirement.

Here, regarding the two-dimensional array afmi_tile_in_submesh_flag[afmi_submesh_id[i]][afti_tile_id[j]], in a case that multiple pieces of tile information include the submesh information having the submesh ID (afmi_submesh_id[i]) of the submesh of index i, a restriction that indices TileIDToIndex[afti_tile_id[j]] of the tile information need to be consecutive indices such as 0, 1, and 2 and the same submesh information does not include (shall not include) the tile information of non-consecutive indices such as 1, 3, and 5 and 1, 2, and 4 may be a conformance requirement.

Here, in a case that numTiles=3, numSubMeshes=2, and afmi_signalled_submesh_id_flag=0, examples of values of afmi_tile_in_submesh_flag[afmi_submesh_id[i]][afti_tile_id[j]] in a case that afmi_submesh_id[0] includes afti_tile_id[1] and afti_tile_id[2] and afmi_submesh_id[1] includes afti_tile_id[0] are illustrated.

$$afmi\_tile \_in \_submesh \_flag [ 0 ] [ 0 ] = 0 \\ afmi\_tile \_in \_submesh \_flag [ 0 ] [ 1 ] = 1 \\ afmi\_tile \_in \_submesh \_flag [ 0 ] [ 2 ] = 1 \\ afmi\_tile \_in \_submesh \_flag [ 1 ] [ 0 ] = 1 \\ afmi\_tile \_in \_submesh \_flag [ 1 ] [ 1 ] = 0 \\ afmi\_tile \_in \_submesh \_flag [ 1 ] [ 2 ] = 0$$

Here, the mesh patch information decoder 3025 derives the tile-level mesh patch information as follows.

```
for( si = 0; si < afmi_num_submeshes_minus2 + 2; si++ ) {
  submeshID = SubMeshIndexToID[ si ]
  for( t = 0; t <= afti_num_tiles_in_atlas_frame_minus1; t++ ) {
    tileID = TileIndexToID[ t ]
    if( afmi_tile_in_submesh_flag[ submeshID ][ tileID ] ) {
      AtduTotalNumMeshpatches[ tileID ] = MaxNumMeshpatches
      for( p = 0; p <= AtduTotalNumMeshpatches[ tileID ]; p++ ) {
        ...
        TileMeshpatchSubmeshID[ tileID ][ p ] = submeshID
        ...
      }
    }
  }
}
```

In a case that multiple mesh patches correspond to one submesh, the mesh patch information decoder 3025 may derive the tile-level mesh patch information as follows.

```
for( si = 0; si < afmi_num_submeshes_minus2+2; si++ ) {
  submeshID = SubMeshIndexToID[ si ]
  for( t = 0; t <= afti_num_tiles_in_atlas_frame_minus1; t++ ) {
    tileID = TileIndexToID[ t ]
    if( afmi_submesh_in_tile_flag[ submeshID ][ tile ID ] ) {
      AtduTotalNumMeshpatches[ submeshID ][ tileID ] = MaxNumMeshpatches
      for( p = 0; p <= AtduTotalNumMeshpatches[ submeshID ][ tileID ]; p++ ){
        TileMeshpatch2dPosX[ submeshID ][ tileID ][ p ] =
          mdu_2d_pos_x[ submeshID ][ tileID ][ p ] * PatchPackingBlockSize
        TileMeshpatch2dPosY[ submeshID ][ tileID ][ p ] =
          mdu_2d_pos_y[ submeshID ][ tileID ][ p ] * PatchPackingBlockSize
        TileMeshpatch2dSizeX[ submeshID ][ tileID ][ p ] =
          (mdu_2d_size_x_minus1[ submeshID ][ tileID ][ p ] + 1) *
            P PatchSizeXQuantizer
        TileMeshpatch2dSizeY[ submeshID ][ tileID ][ p ] =
          (mdu_2d_size_y_minus1[ submeshID ][ tileID ][ p ] + 1) *
            PatchSizeYQuantizer
        for( attrIdx = 0; attrIdx < asve_num_attribute_video; attrIdx){
          TileMeshpatchAttributes2dPosX[submeshID][tileID][p][attrIdx] =
            mdu_attributes_2d_pos_x[ submeshID ][ tileID ][ p ][ attrIdx ]
          TileMeshpatchAttributes2dPosY[submeshID][tileID][p][attrIdx] =
            mdu_attributes_2d_pos_y[ submeshID ][ tileID ][ p ][ attrIdx ]
          TileMeshpatchAttributes2dSizeX[submeshID][tileID][p][attrIdx] =
            (mdu_attributes_2d_size_x_minus1[submeshID][tileID][p][attrIdx] +
              1) * PatchSizeXQuantizer
          TileMeshpatchAttributes2dSizeY[submeshID][tileID][p][attrIdx] =
            (mdu_attributes_2d_size_y_minus1[submeshID][tileID][p][attrIdx] +
              1) * PatchSizeYQuantizer
        }
        TileMeshpatchSubmeshID[ submeshID ][ tileID ][ p ] = submeshID
        TileMeshpatchDisplID[ submeshID ][ tileID ][ p ] =
          mdu_displ_id[ submeshID ][ tileID ][ p ]
        TileMeshpatchSubdivCount[ submeshID ][ tileID ][ p ] =
          PatchSubdivisionCount[ tileID ][ patchIdx ]
        for( i = 0; i<TileMeshpatchSubdivCount[submeshID][tileID][p] ; i++ ){
          TileMeshpatchSubdivMethod[ submeshID ][ tileID ][ p ][ i ] =
            PatchSubdivisionMethod[ submeshID ][ titleID ][ p ][ i ]
        }
        TileMeshpatchDispCoordSys[ submeshID ][ tileID ][ p ] =
          mdu_displacement_coordinate_system[ submeshID ][ tileID ][ p ]
        TileMeshpatchTransformMethod[ submeshID ][ tileID ][ p ] =
          mdu_transform_method[ submeshID ][ tileID ][ p ]
        ...
      }
    }
  }
}
```

As in afmi_tile_in_submesh_flag[SubMeshIDToIndex[afmi_submesh_id[i]]][TileIDToIndex[afti_tile_id[j]]], encoding and decoding may be performed by invariably using indices instead of IDs.

In the syntax structure of FIG. 22, the syntax element afmi_tile_in_submesh_flag[i][j] may be encoded and decoded by using indices such as i and j without using IDs of the syntax elements afmi_submesh_id[i] and afti_tile_id[j] as follows.

```
atlas_frame_mesh_information( ) {
  ...
  for( i = 0; i < NumSubMeshes; i++ ) {
    for( j = 0; j < NumTiles; j++ ) {
      afmi_tile_in_submesh_flag[ i ][ j ]
    }
  }
  ...
}
```

Here, the submesh ID of the submesh of index i can be derived from SubMeshIndexToID[i], and the tile ID of the tile of index j can be derived from TileIndexToID[j].

According to the configuration described above, coded data can derive correspondence between the tile information and the submesh information, the tile information and the mesh patch information, and the submesh information and the mesh patch information on a submesh basis by using a flag indicating whether or not the tile information having any tile ID decoded in the submesh information decoder and the submesh information having any submesh ID have correspondence. Therefore, there is an effect that, by identifying the tile information and the mesh patch information corresponding to any submesh, only the tile information and the mesh patch information necessary for reconstruction of any submesh can be decoded.

A flag tmsm_tile_in_submesh_flag[tmsm_submesh_id[i]][tmsm_tile_id[j]] indicating whether or not the submesh information having the submesh ID of the submesh of index i includes the tile information having the tile ID of the tile of index j may be transmitted using SEI. The following example may be used for semantics.

tmsm_tile_in_submesh_flag[tmsm_submesh_id[i]][tmsm_tile_id[j]]: indicates whether or not the submesh information having the submesh ID of the submesh of index i includes the tile information having the tile ID of the tile of index j. In a case that the flag has a value of 1, it indicates that the submesh information having the submesh ID (tmsm_submesh_id[i]) of the submesh of index i includes the tile information having the tile ID (tmsm_tile_id[j]) of the tile of index j, and in a case that the flag has a value of 0, it indicates that the submesh information having the submesh ID (tmsm_submesh_id[i]) of the submesh of index i does not include the tile information having the tile ID (tmsm_tile_id[j]) of the tile of index j.

Here, the mesh patch information decoder 3025 may derive the tile-level mesh patch information by using the syntax element tmsm_tile_in_submesh_flag[tmsm_submesh_id[i]][tmsm_tile_id[j]].

### Decoding of Base Mesh

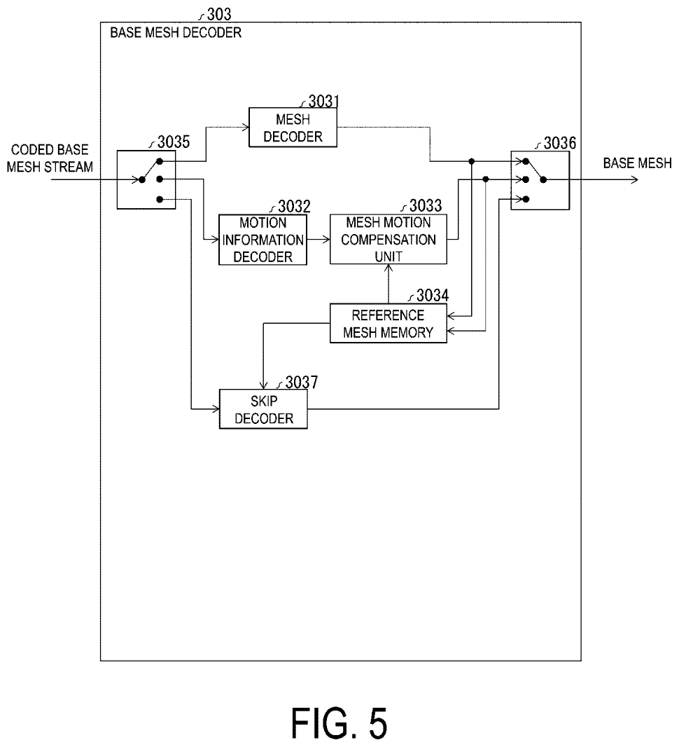

FIG. 5 is a functional block diagram illustrating a configuration of the base mesh decoder 303. The base mesh decoder 303 includes a mesh decoder 3031, a motion information decoder 3032, a mesh motion compensation unit 3033, a reference mesh memory 3034, a switch 3035, a switch 3036, and a skip decoder 3037. The base mesh decoder 303 may include a base mesh inverse quantization unit (not illustrated) prior to output of the base mesh. In a case that the target base mesh to be decoded is encoded (intra-coded) without referring to another base mesh (for example, an already coded and decoded base mesh), the switch 3035 and the switch 3036 are connected on the mesh decoder 3031 side. In contrast, in a case that the target base mesh to be decoded is encoded (inter-coded) by referring to another base mesh, they are connected on the side to perform motion compensation. In a case that motion compensation is performed, the target vertex coordinates are derived by referring to already decoded vertex coordinates and motion information. In contrast, in a case that the target base mesh to be decoded is skipped and another base mesh is encoded (skip-coded) as the target to be decoded, they are connected on the skip decoder 3037 side.

Each base mesh includes one or multiple submeshes. In a case that multiple submeshes are present, the tile header in an atlas data sub-bitstream requires an ID to search for a submesh corresponding to the tile. Here, the submesh is a subset of meshes defined by indicating a part of a three-dimensional model, and is a mesh obtained by dividing a mesh into multiple parts. By dividing meshes into a subset to finely control a part of the three-dimensional model, meshes in a specific range can be individually defined. Each submesh includes unique vertex coordinates, normal vectors, texture coordinates, and the like, and can be individually operated and edited. A mesh of a certain frame is referred to as a mesh frame.

The mesh decoder 3031 decodes a coded base mesh stream that has been intra-coded and outputs a base mesh (a base mesh vertex position, a base mesh vertex position vector). Draco, edge breaker, or the like is used as a coding scheme.

The motion information decoder 3032 decodes a coded base mesh stream that has been inter-coded and outputs motion information (mesh motion information, a mesh motion vector) for each vertex of a reference mesh which will be described later. Entropy coding such as arithmetic coding is used as a coding scheme.

The mesh motion compensation unit 3033 performs motion compensation on each vertex of the reference mesh received from the reference mesh memory 3034 based on the motion information and outputs a motion-compensated mesh.

The reference mesh memory 3034 is a memory that holds decoded meshes for reference in subsequent decoding processing.

### Decoding of Mesh Displacements

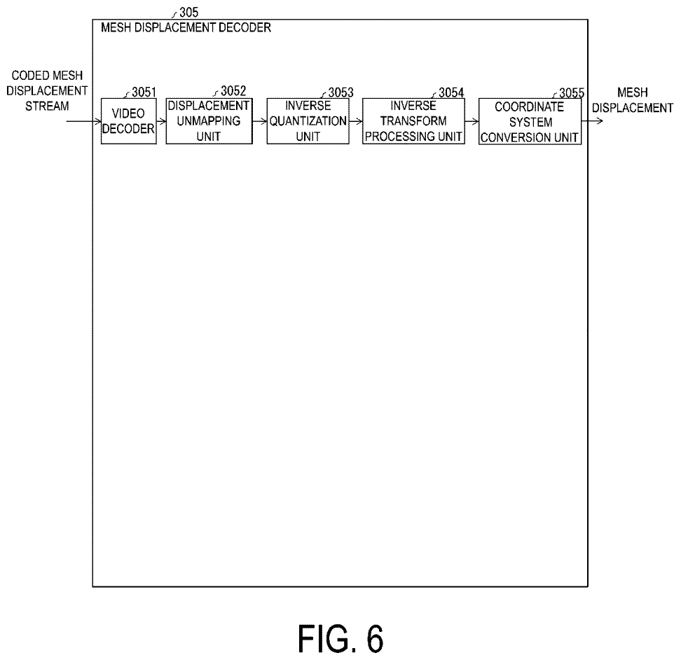

FIG. 6 is a functional block diagram illustrating a configuration of the mesh displacement decoder 305. The mesh displacement decoder 305 includes a displacement unmapping unit 3052 (an image unpacker or a displacement decoder), an inverse quantizing unit 3053, an inverse transform processing unit 3054, and a coordinate system conversion unit 3055. The displacement unmapping unit may also be referred to as a “displacement mapping unit”. The mesh displacement decoder 305 may further include a video decoder 3051 as illustrated in FIG. 5 or may not include the video decoder 3051 and may be configured to use the 3D data decoding apparatus 31 for decoding displacement images (displacement arrays). The mesh displacement decoder 305 may also not include the inverse quantizing unit 3053 and may be configured such that only the 3D data decoding apparatus 31 performs image quality control.

The atlas information decoder 302 decodes coordinate system conversion information displacementCoordinateSystem (mdu_displacement_coordinate_system) indicating a coordinate system from coded data. Submesh subdivision information (a displacement submesh subdivision parameter, a displacement segment parameter, a displacement submesh subdivision flag, and a displacement segment flag) of mesh displacements may be decoded. The submesh subdivision information may be displacementSubmeshFlag indicating whether or not division into segments is performed. The submesh subdivision information may further include a component height origHeight. The submesh subdivision information may further include a component width origWidth. The submesh subdivision information may include a syntax element dispPos[lodIdx] indicating the start position of mesh displacements for each LOD or the number dispCount[lodIdx] of mesh displacements for each LOD. The slice division information may also include an index dispCountIdx[lodIdx] indicating the number of mesh displacements. The submesh subdivision information may include a block size ctuSize for alignment of submeshes or an index ctuSizeIdx indicating ctuSize. The component height is a parameter indicating the height of an image corresponding to each of the components (for example, n, t, and b) of three-dimensional mesh displacement vectors.

Note that a gating flag may also be provided separately and each piece of coordinate system conversion information may be decoded only in a case that the gating flag is 1. The gating flag is afve_overriden_flag, for example. A gating flag may also be provided in the submesh subdivision information and the submesh subdivision information may be decoded only in a case that the gating flag is 1. The gating flag is afve_displacement_submesh_alignment_flag, for example.

### Coordinate Systems

The following two types of coordinate systems are used as coordinate systems for mesh displacements (three-dimensional vectors).

Cartesian coordinate system (canonical): An orthogonal coordinate system that is commonly defined throughout 3D space. An (X, Y, Z) coordinate system. An orthogonal coordinate system whose directions do not change at the same time (within the same frame or within the same tile).

Local coordinate system (local): An orthogonal coordinate system defined for each region or each vertex in 3D space. An orthogonal coordinate system whose directions can change at the same time (within the same frame or within the same tile). A coordinate system with a normal axis (D), a tangent axis (U), and a bi-tangent axis (V). That is, the local coordinate system is an orthogonal coordinate system that has a first axis (D) indicated by a normal vector n_vec at a certain vertex (on a surface including a certain vertex) and a second axis (U) and a third axis (V) indicated by two tangent vectors t_vec and b_vec orthogonal to the normal vector n_vec. n_vec, t_vec, and b_vec are three-dimensional vectors. The (D, U, V) coordinate system may also be referred to as an (n, t, b) coordinate system.

### Operation of Mesh Displacement Decoder

The video decoder 3051 decodes a geometry video stream (a V3C_GVD video stream) that has been encoded using VVC, HEVC, or the like and outputs a decoded image (a mesh displacement image or a mesh displacement array) whose pixel values are (quantized) mesh displacements. The color components of the geometry are represented by DecGeoChromaFormat. The image may be in a YCbCr 4:2:0 format. The mesh displacement image may also be a transformed mesh displacement image. The mesh displacement image may also be a residual of a mesh displacement image.

The displacement unmapping unit 3052 generates mesh displacements from the mesh displacement image. Specifically, a mesh displacement dispQuantCoeffArray[v][d] which is a one-dimensional signal in units of components d is derived from dispQuantCoeffFrame[x][y][d], which is a two-dimensional mesh displacement image, according to the correspondence of coordinate positions. Note that dispQuantCoeffFrame may be an image array DecGeoFrames[mapIdx][frameIdx] or GeoFramesNF[mapIdx][compTimeIdx] decoded in a codec from a geometry video stream (a V3C_GVD video stream). Here, the correspondence of coordinate positions may be that of a Z-order scan in units of blocks. NF is an abbreviation for nominal format and is an image whose image size, color sampling, or the like has been adjusted. The frameIdx and compTimeIdx are composition time indices.

The displacement unmapping unit 3052 derives DisplacementDim according to the value of the flag asve_1d_displacement_flag indicating whether one-dimensional displacements decoded from coded data are used.

$$DisplacementDim = ( asve\_ 1 d\_displacement \_flag ) ? 1 : 3 \\ Have , asve\_ 1 d\_displacement \_flag = 1 indicates that only one ‐ dimensions of three ‐$$

Here, asve_1d_displacement_flag=1 indicates that only one-dimensions of three-dimensional displacements are transmitted. This indicates that normal or x components (first components) of displacements are present in a (compressed) geometry image. In a case that the one-dimensional flag is true, the displacement unmapping unit 3052 infers that the remaining two components are zero. asve_1d_displacement_flag=0 indicates that all three components of displacements are present in the (compressed) geometry image.

The displacement unmapping unit 3052 may decode ctuSize from coded data in NAL units of an atlas, for example, from a syntax element of an ASPS. The displacement unmapping unit 3052 may also decode the value of ctuSizeIdx (videoBlockSizeIdx) and derive ctuSize from 16<<ctuSizeIdx, 32<<ctuSizeIdx, or 64<<ctuSizeIdx.

For example, the displacement unmapping unit 3052 may use 64 in a case that gi_geometry_codec_id[DecAtlasID] is HEVC and 128 in a case that it is VVC as described below.

$$ctuSize = ptl\_profile \_codec \_group \_idc == 3 ( VVC ) ? 128 : 64$$

Here, the value of ptl_profile_codec_group_idc being 0 indicates AVC Progressive High, 1 indicates HEVC Main 10, 2 indicates HEVC Main 444, and 3 indicates VVC Main 10.

$$4 CC code of ctuSize = gi\_geometry \_codec \_id [ DecAtlasID ] indiates HEVC ? 64 : 128$$

Here, the character strings of 4CC codes indicating HEVC and VVC are “hev1” and “vvi1”, respectively.

Alternatively, the displacement unmapping unit 3052 may use, as a constant value, the maximum value 128, which is the larger of the maximum value 64 of the HEVC CTU size and the maximum value 128 of the VVC CTU size.

In one configuration, the displacement unmapping unit 3052 receives an input of a three-dimensional array dispQuantCoeffFrame of size asps_frame_width×asps_frame_height×DisplacementDim, variables patch2dSizeX, patch2dSizeY, patch2dPosX, patch2dPosY, bitDepth, and subdivisionIterationCount, the number verCoordCount of vertices, and an array levelOfDetailVertexCounts having a size of subdivisionIterationCount+1, and derives a two-dimensional array dispQuantCoeffArray having a size of verCoordCount×DisplacementDim, which indicates quantized displacement wavelet coefficients. The two-dimensional array dispQuantCoeffArray is initialized to 0. All elements of vStart, vEnd, and startBlock of the one-dimensional array having a size of subdivisionIterationCount+1 are initialized as 0, and a variable blockCount is set equal to 0.

Here, patch2dSizeX indicates the width of the bounding box of the patch, patch2dSizeY indicates the height of the bounding box of the patch, patch2dPosX indicates the x-coordinate at the top left corner of the bounding box of the patch, and patch2dPosY indicates the y-coordinate at the top left corner of the bounding box of the patch. For example, parameters may be derived from the ASPS as bitDepth=asps_geometry_3d_bit_depth_minus1+1 and subdivisionIterationCount=asve_subdivision_iteration_count. blockSize may be ctuSize.

Each variable may be derived as follows.

```
patchWidthInBlocks =
    (patch2dSizeX + blockSize − 1) / blockSize
pixelsPerBlock = blockSize * blockSize
shift = (1 << bitDepth) >> 1
if ( subdivisionIterationCount = 0 ) {
    vEnd[ 0 ] = verCoordCount
    blockCount =
        ( verCoordCount + blockSize − 1 ) / blockSize
} else {
    for( i = 0; i < subdivisionIterationCount + 1; i++ ) {
        vStart[ i ] = i == 0? 0 : levelOfDetailVertexCounts[ i − 1 ]
        vEnd[ i ] = levelOfDetailVertexCounts[ i ]
        blockCountLevel [ i ] =
          (vEnd[ i ] − vStart[ [symbol] ] + blockSize − 1) / blockSize
        startBlock[ i ] = i == 0 ? 0 :
        (startBlock[ i − 1 ] + blockCount [ i ])
        blockCount [symbol] = blockCountLevel[ i ]
      }
  } [symbol]
indicates data missing or illegible when filed
```

Here, a variable dispPackingOrder is set equal to a syntax element asve_packing_method decoded from coded data, and a variable videoChromaFormat is set equal to a variable DecGeoChromaFormat of a decoded geometry video component. dispQuantCoeffArray may be derived as follows.

```
heightInBlocks = (blockCount + widthInBlocks − 1) / patchWidthInBlocks
origHeight = heightInBlocks * blockSize
totalBlocksInPatch = ( patch2dSizeX * origHeight ) / pixelsPerBlock
for( lodIdx = 0; lodIdx < subdivisionIterationCount + 1; lodIdx++ ) {
  for( v = vStart[ lodIdx ]; [symbol] < vEnd[ lodIdx ]; v++ ) {
    blockIndex = (v−vStart[ lodIdx ]) / pixelsPerBlock + startBlock[ lodIdx ]
    indexWithinBlock = ( v − vStart[ lodIdx ] ) % pixelsPerBlock
    if( dispPackingOrder ) {
      blockIndex = totalBlocksInVideoFrame − 1 − blockIndex
      indexWithinBlock = pixelsPerBlock − 1 − indexWithinBlock
    }
    x0 = ( blockIndex % widthInBlocks ) * blockSize
    y0 = ( blockIndex / widthInBlocks ) * blockSize
    ( x, y ) = computeMorton2D( indexWithinBlock )
    x1 = x0 + x + patch2dPosX
    y1 = y0 + y + patch2dPosX
    for( d = 0; d [symbol] DisplacementDim: d++ ) {
      if ( videoChromaFormat == 4:2:0 || videoChromaFormat == 4:2:2 ||
          videoChromaFormat == 4:0:0 ) {
        if( dispPackingOrder )
        dispQuantCoeffArray[ v ][ d ] =
            dispQuantCoeffFrame[ x1 ][ d * origHeight + y1 ][ 0 ] − shift
      } else {
        dispQuantCoeffArray[ v ][ d ] =
            dispQuantCoeffFrame[ x1 ][ y1 ][ d ] − shift
      }
    }
  }
} [symbol]
indicates data missing or illegible when filed
```

Here, asve_packing_method=0 indicates that displacement component samples are packed in ascending order. asve_packing_method=1 indicates that displacement component samples are packed in descending order. computeMorton2D is a function for realizing the Z-order scan and is defined as follows.

```
x = extracOddBits(x) {
  x = x & 0x55555555
  x = (x | (x >> 1)) & 0x33333333
  x = (x | (x >> 2)) & 0x0F0F0F0F
  x = (x | (x >> 4)) & 0x00FF00FF
  x = (x | (x >> 8)) & 0x0000FFFF
}
(x, y) = computeMorton2D(i) {
  x = extracOddBits(i>>1)
  y = extracOddBits(i)
}
```

In another configuration, the displacement unmapping unit 3052 may decode and derive the mesh displacement for each submesh.

The displacement unmapping unit 3052 may add a conformance restriction that one or both of origHeight and origWidth derived from afve_displacement_component_height_submesh[i], afve_displacement_component_width_submesh[i], and the like are an integer multiple of ctuSize.

$$heightInBlocks = ( blockCount [ submeshIdx ] + widthInBlocks - 1 ) / patchWidthInBlocks$$

$$origHeight = heightInBlocks * blockSize$$

In another configuration, without decoding or coding afve_displacement_component_width_submesh[i] indicating the width of each component of the submesh corresponding to index i of the mesh displacement obtained by performing submesh subdivision, the displacement unmapping unit 3052 may derive the width of each component of the submesh corresponding to index i of the mesh displacement obtained by performing submesh subdivision as follows.

$$widthInBlocks = ( blockCount [ submeshIdx ] + heightInBlocks - 1 ) / patchHeightInBlocks$$

$$origWidth = widthInBlocks * blockSize$$

The inverse quantization unit 3053 performs inverse quantization based on a quantization scale value iscale to derive a transformed (for example, wavelet-transformed) mesh displacement dispCoeffArray. dispCoeffArray may be a value in a Cartesian coordinate system or a local coordinate system. iscale is a value derived from the quantization parameter of each component of a mesh displacement image.

```
Vcount0 = 0
for( i = 0; 1 < subdivisionIterationCount; i++ ) {
  vcount1 = levelOfDetailCounts[ i ]
  for( v = vcount0; v [symbol] vcount1; v++ ) {
    for( d = 0; d < DisplacementDim; d++ ) {
      dispCoeffArray[v][d] = dispQuantCoeffArray[ v ][ d ] *
      iscale[ i ][ d ]
    }
  }
  vcount0 = vcount1
} [symbol]
indicates data missing or illegible when filed
```

Here, iscale is derived as follows.

```
lodQuantizationFlag = vqp_lod_quantization_flag[ QpIndex ]
directQuantizationEnableFlag = vqp_direct_quantization_enabled_flag[QpIndex]
for( lodIdx = 0; lodIdx < subdivisionIterationCount + 1; lodIdx++ ) {
    for( dimIdx = 0; dimIdx < DisplacementDim; dimIdx ++ ) {
        iscale[ lodIdx ][ dimIdx ] = InverseScale[ QpIdx ][ lodIdx ][ dimIdx ]
        }
    }
} else {
    for( dimIdx = 0; dimIdx [symbol] DisplacementDim; dimIdx++ ) {
        iscale[ 0 ][ dimIdx ] = InverseScale[ QpIdx ][ 0 ][ dimIdx ]
        levelOfDetailInverseScale[ dimIdx ] =
          1 << vqp_log2_lod_inverse_scale[ QpIdx ][ dimIdx ]
    }
    for( lodIdx = 1; lodIdx < lodCount; lodIdx++ ) {
        for( dimIdx = 0; dimIdx < DisplacementDim; dimIdx++ ) {
          iscale[ lodIdx ][ dimIdx ] = iscale[ lodIdx − 1 ][ dimIdx ] *
            levelOfDetailInverseScale[ dimIdx ]
        }
      }
  } [symbol]
indicates data missing or illegible when filed
```

The inverse transform processing unit 3054 performs an inverse transform g (for example, an inverse wavelet transform) and derives a mesh displacement d.

$$d [ d ] [ v ] = g ( dispCoeffArray [ v ] [ d ] )$$

The coordinate system conversion unit 3055 converts the mesh displacement (the coordinate system for mesh displacements) into a Cartesian coordinate system based on the value of coordinate system conversion information displacementCoordinateSystem. Specifically, in a case that displacementCoordinateSystem=1, a displacement in the local coordinate system is converted to a displacement in the Cartesian coordinate system. Here, d is a three-dimensional vector indicating a mesh displacement before coordinate system conversion. disp is a three-dimensional vector indicating a mesh displacement after coordinate system conversion and is a value in the Cartesian coordinate system. n_vec, t_vec, and b_vec are three-dimensional vectors (in the Cartesian coordinate system) corresponding to the axes of a local coordinate system of a target region or target vertex.

```
if (displacementCoordinateSystem == 0) {
  disp = d
} else if (displacementCoordinateSystem == 1){
  disp = d[0] * n_vec + d[1] * t_vec + d[2] * b_vec
}
```

Derivation methods described above using vector multiplication can be individually expressed as scalars as follows.

```
if (displacementCoordinateSystem == 0) {
  for (i = 0; i < 3; i++) {
    disp[i]= d[i]
  }
} else if (displacementCoordinateSystem == 1){
  for (i = 0; i < 3; i++) {
    disp[i]= d[0] * n_vec[i]+ d[1] * t_vec[i]+ d[2] * b_vec[i]
  }
}
```

Note that it is also possible to adopt a configuration in which the same variable name is assigned to the values before and after conversion such that disp=d and the value of d is updated through coordinate conversion.

Alternatively, the following configuration may be used.

```
if (displacementCoordinateSystem == 0) {
  disp = d
} else if (displacementCoordinateSystem == 1){
  disp = d[0] * n_vec + d[1] * t_vec + d[2] * b_vec
} else if (displacementCoordinateSystem == 2){
  disp = d[0] * n_vec2 + d[1] * t_vec2 + d[2] * b_vec2
}
```

Here, n_vec2, t_vec2, and b_vec2 are three-dimensional vectors (in the Cartesian coordinate system) corresponding to the axes of a local coordinate system of an adjacent region.

Alternatively, the following configuration may be used.

```
if (displacementCoordinateSystem == 0) {
  disp = d
} else if (displacementCoordinateSystem == 1){
  disp = d[0] * n_vec3 + d[1] * t_vec3 + d[2] * b_vec3
}
```

Here, n_vec3, t_vec3, and b_vec3 are three-dimensional vectors (in the Cartesian coordinate system) corresponding to the axes of a local coordinate system of a target region with reduced fluctuations. For example, vectors in the coordinate system used for decoding are derived from the previous coordinate system and the current coordinate system as follows.

$$n\_vec3 = ( w * n\_vec3 + ( WT - w ) * n\_vec ) ≫ wShift$$

$$t\_vec3 = ( w * t\_vec3 + ( WT - w ) * t\_vec ) ≫ wShift$$

$$b\_vec3 = ( w * b\_vec3 + ( WT - w ) * b\_vec ) ≫ wShift$$

Here, each variable may be a value of wShift=2, 3, 4, WT=1<<wShift, w=1 . . . WT−1, or the like. For example, in a case that w=3 and wShift=3, the following may be true.

$$n\_vec3 = ( 3 * n\_vec3 + 5 * n\_vec ) ≫ 3$$

$$t\_vec3 = ( 3 * t\_vec3 + 5 * t\_vec ) ≫ 3$$

$$b\_vec3 = ( 3 * b\_vec3 + 5 * b\_vec ) ≫ 3$$

The vectors may be selected according to the value of coordinate system conversion information displacementCoordinateSystem decoded from coded data as in the following configuration.

if (displacementCoordinateSystem == 0) {
disp = d
} else if (displacementCoordinateSystem == 1){
disp = d[0] * n_vec + d[1] * t_vec + d[2] * b_vec
} else if (displacementCoordinateSystem == 6){
disp = d[0] * n_vec3 + d[1] * t_vec3 + d[2] * b_vec3

### Reconstruction of Mesh

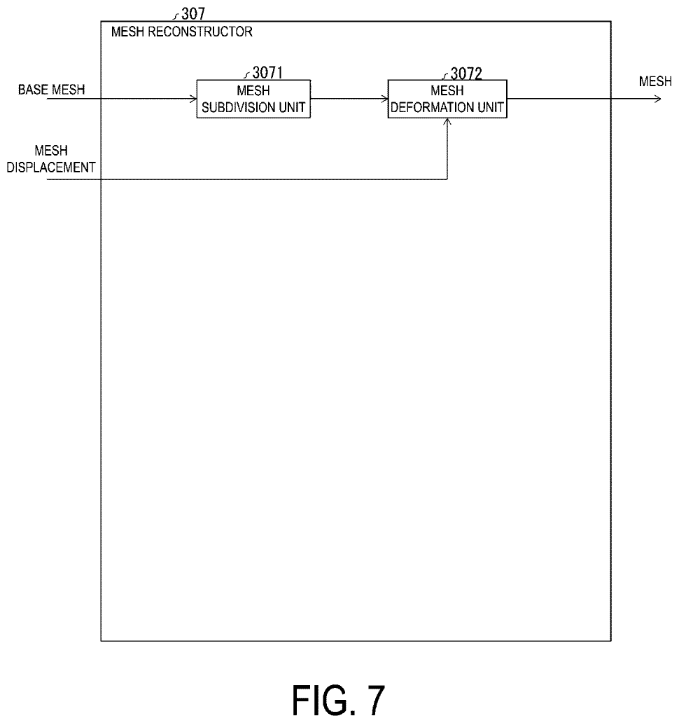

FIG. 7 is a functional block diagram illustrating a configuration of the mesh reconstructor 307. The mesh reconstructor 307 includes a mesh subdivision unit 3071 and a mesh deformation unit 3072.

The mesh subdivision unit 3071 subdivides a base mesh output from base mesh decoder 303 to generate a subdivided mesh.

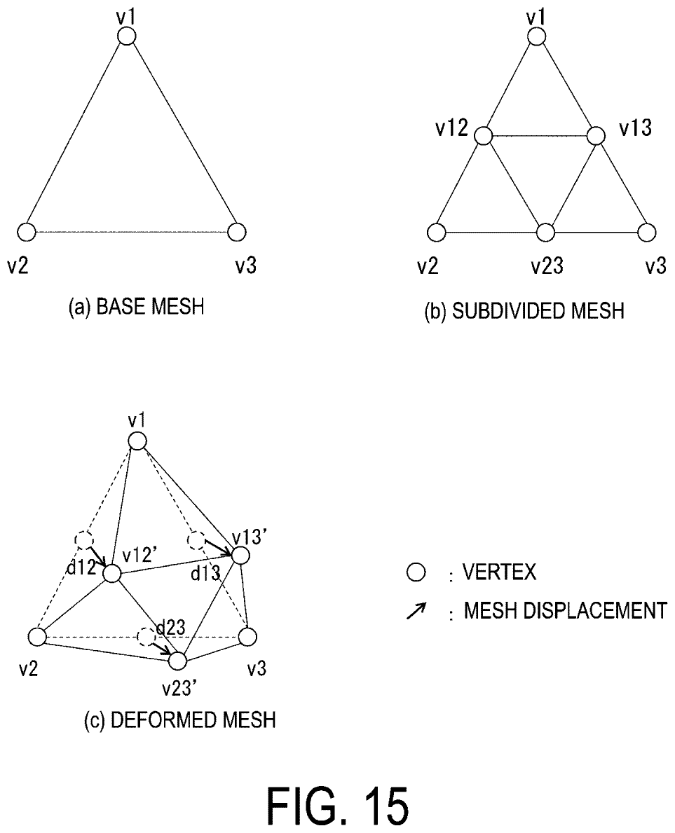

FIG. 15(a) illustrates a part (a triangle) of a base mesh and the triangle includes vertices v1, v2, and v3. v1, v2, and v3 are three-dimensional vectors. The mesh subdivision unit 3071 generates subdivided meshes by adding new vertices v12, v13, and v23 to the middle of the respective sides of the triangle, and outputs the subdivided meshes (FIG. 15(b)).

$$v 12 = ( v 1 + v 2 ) / 2$$

$$v 13 = ( v 1 + v 3 ) / 2$$

$$v 23 = ( v 2 + v 3 ) / 2$$

The following may also be used.

$$v 12 = ( v 1 + v 2 + 1 ) ≫ 1$$

$$v 13 = ( v 1 + v 3 + 1 ) ≫ 1$$

$$v 23 = ( v 2 + v 3 + 1 ) ≫ 1$$

The mesh deformation unit 3072 receives the subdivided meshes and mesh displacements, generates a deformed mesh by adding the mesh displacements d12, d13, and d23, and outputs the deformed mesh (FIG. 15(c)). The mesh displacements d12, d13, and d23 are the output of the mesh displacement decoder 305 (the coordinate system conversion unit 3055). The mesh displacements d12, d13, and d23 are mesh displacements corresponding to the vertices v12, v13, and v23 added by the mesh subdivision unit 3071.

$$v {12}^{′} = v 12 + d 12$$

$$v {13}^{′} = v 13 + d 13$$

$$v {23}^{′} = v 23 + d 23$$

Note that d12=disp[0][ ], d13=disp[1][ ], and d23=disp[3][ ] may be satisfied.

### Configuration of 3D Data Coding Apparatus According to First Embodiment

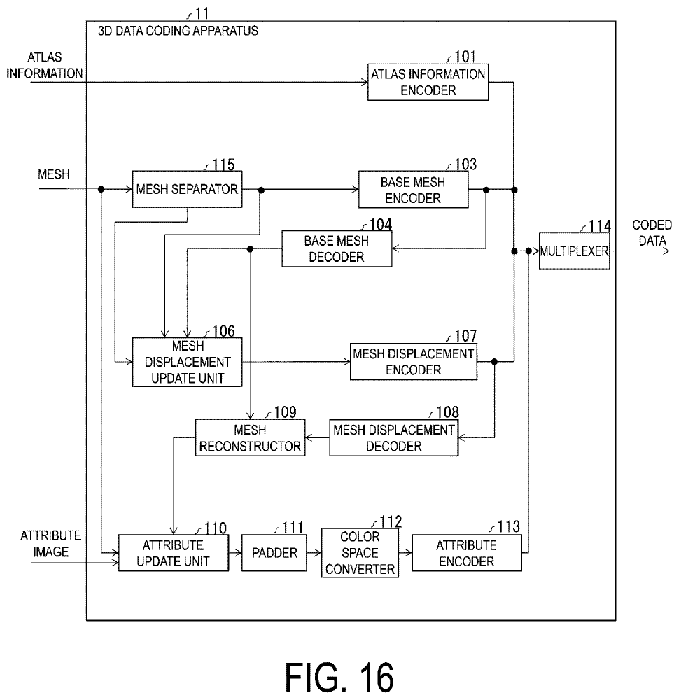

FIG. 16 is a functional block diagram illustrating a schematic configuration of the 3D data coding apparatus 11 according to the first embodiment. The 3D data coding apparatus 11 includes an atlas information encoder 101, a base mesh encoder 103, a base mesh decoder 104, a mesh displacement update unit 106, a mesh displacement encoder 107, a mesh displacement decoder 108, a mesh reconstructor 109, an attribute update unit 110, a padder 111, a color space converter 112, an attribute encoder 113, a multiplexer 114, and a mesh separator 115. The 3D data coding apparatus 11 receives atlas information, a base mesh, mesh displacements, a mesh, and attribute image as 3D data and outputs coded data.

The atlas information encoder 101 encodes the atlas information and outputs a coded atlas information stream.

The base mesh encoder 103 encodes the base mesh and outputs a coded base mesh stream. Draco or the like is used as a coding scheme.

The base mesh decoder 104 is similar to the base mesh decoder 303 and thus description thereof will be omitted.

The mesh displacement update unit 106 adjusts the mesh displacements based on the (original) base mesh and the decoded base mesh and outputs the updated mesh displacement.

The mesh displacement encoder 107 encodes the updated mesh displacements and outputs a coded mesh displacement stream. VVC, HEVC, or the like is used as a coding scheme.

The mesh displacement decoder 108 is similar to the mesh displacement decoder 305 and thus description thereof will be omitted.

The mesh reconstructor 109 is similar to the mesh reconstructor 307 and thus description thereof will be omitted.

The attribute update unit 110 receives the (original) mesh, the reconstructed mesh output from the mesh reconstructor 109 (the mesh deformation unit 3072), and the attribute image and updates the attribute image to match the positions (coordinates) of the reconstructed mesh and outputs the updated attribute image.

The padder 111 receives the attribute image and performs padding processing on an area where pixel values are empty.

The color space converter 112 performs color space conversion from an RGB format to a YCbCr format.

The attribute encoder 113 encodes the YCbCr-format attribute image output from the color space converter 112 and outputs an attribute video stream. VVC, HEVC, or the like is used as a coding scheme.

The multiplexer 114 multiplexes the coded atlas information stream, the coded base mesh stream, the coded mesh displacement stream, and the attribute video stream and outputs the multiplexed data as coded data. A byte stream format, the ISOBMFF, or the like is used as a multiplexing method.

### Operation of Mesh Separator

The mesh separator 115 generates a base mesh and mesh displacements from a mesh.

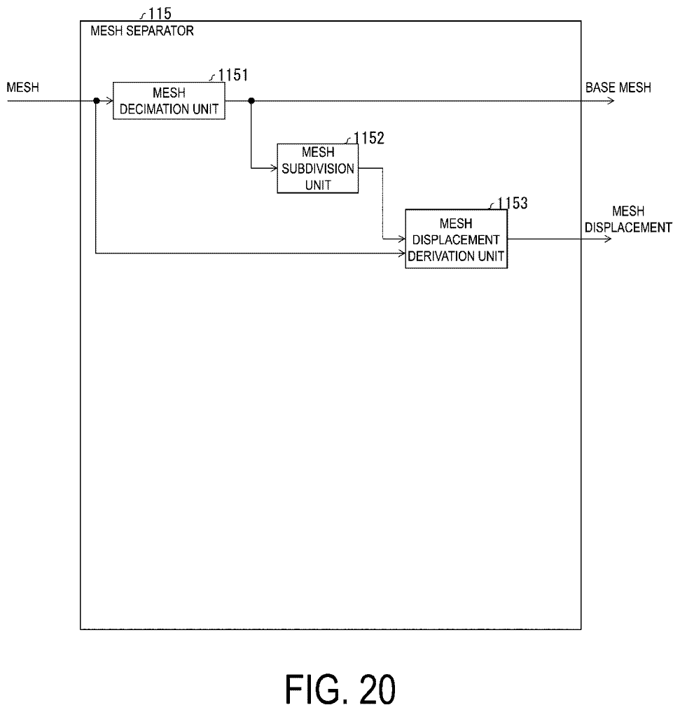

FIG. 20 is a functional block diagram illustrating a configuration of the mesh separator 115. The mesh separator 115 includes a mesh decimation unit 1151, a mesh subdivision unit 1152, and a mesh displacement derivation unit 1153.

The mesh decimation unit 1151 generates a base mesh by removing some vertices from the mesh.

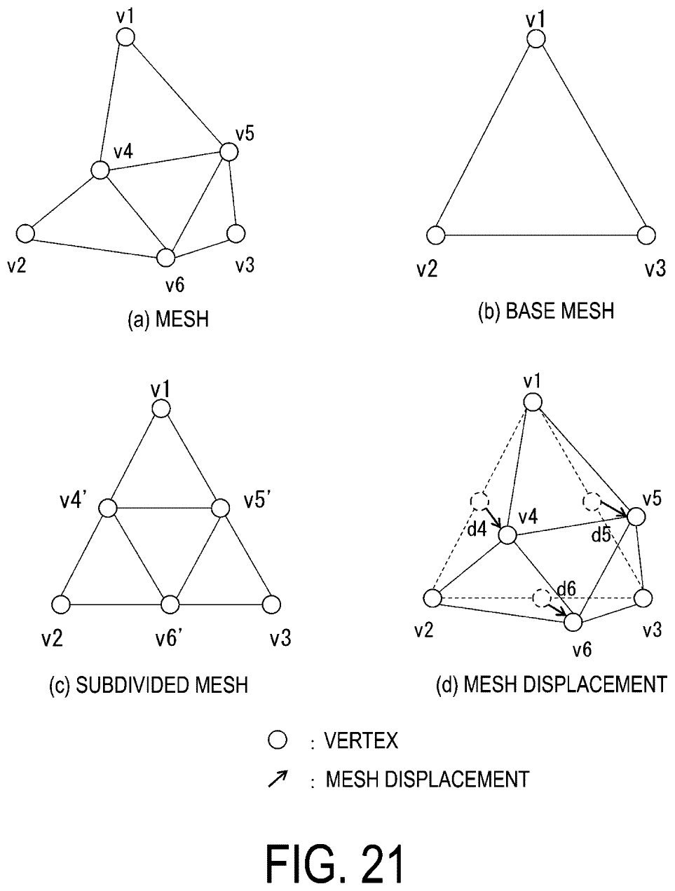

FIG. 21(a) illustrates a part of a mesh, and the mesh includes vertices v1, v2, v3, v4, v5, and v6. v1, v2, v3, v4, v5, and v6 are three-dimensional vectors. The mesh decimation unit 1151 generates a base mesh by decimating the vertices v4, v5, and v6, and outputs the base mesh (FIG. 21(b)).

Like the mesh subdivision unit 3071, the mesh subdivision unit 1152 subdivides the base mesh to generate a subdivided mesh (FIG. 21(c)).

$$v {4}^{′} = ( v 1 + v 2 ) / 2$$

$$v {5}^{′} = ( v 1 + v 3 ) / 2$$

$$v {6}^{′} = ( v 2 + v 3 ) / 2$$

Based on the mesh and the subdivided mesh, the mesh displacement derivation unit derives, as mesh displacements, displacements d4, d5, and d6 of the vertices v4, v5, and v6 with respect to the vertices v4′, v5′, and v6′ and outputs the displacements d4, d5, and d6 (FIG. 21(d)).

$$d 4 = v 4 - v {4}^{′}$$

$$d 5 = v 5 - v {5}^{′}$$

$$d 6 = v 6 - v {6}^{′}$$

### Coding of Atlas Information

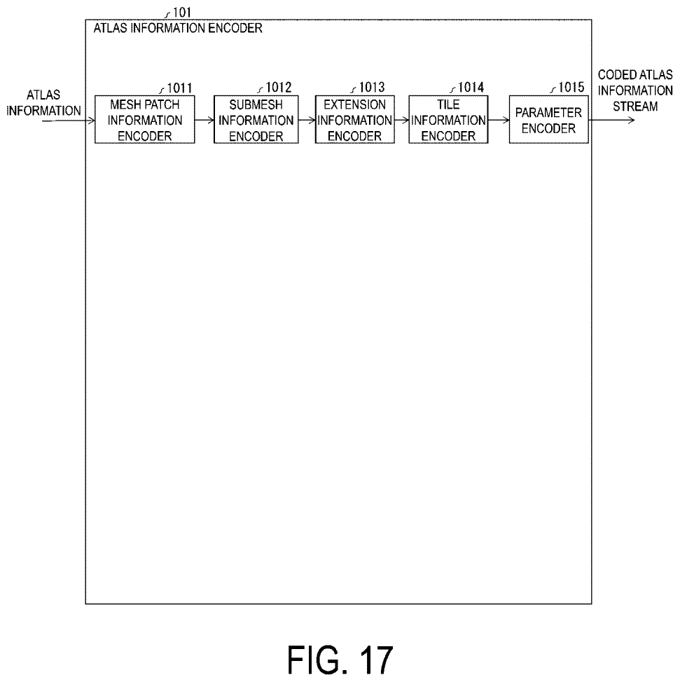

FIG. 17 is a functional block diagram illustrating a configuration of the atlas information encoder 101. The atlas information encoder 101 includes a mesh patch information encoder 1011, a submesh information encoder 1012, an extension information encoder 1013, a tile information encoder 1014, and a parameter encoder 1015.

The mesh patch information encoder 1011 encodes mesh patch information including mesh patch data.

The mesh patch information encoder 1011 may encode correspondence between submesh information having any submesh ID and a mesh patch having a certain patch index.

The submesh information encoder 1012 encodes the number of submeshes and the submesh IDs referred to at the picture/frame level.

The submesh information encoder 1012 may encode the number of submeshes and the submesh IDs referred to at the picture/frame tile level, and in a case that the submeshes to be referred to include tiles, the submesh information encoder 1012 may encode the number of tiles and the tile IDs to be referred to correspond to the submesh IDs.

The submesh information encoder 1012 may encode correspondence between tile information having any tile ID and submesh information having any submesh ID.

The extension information encoder 1013 encodes extension coding parameters related to mesh data.

The tile information encoder 1014 encodes the number of tiles and the tile IDs to be referred to at the picture/frame level.

The parameter encoder 1015 encodes coding parameters related to 3D data.

### Coding of Base Mesh

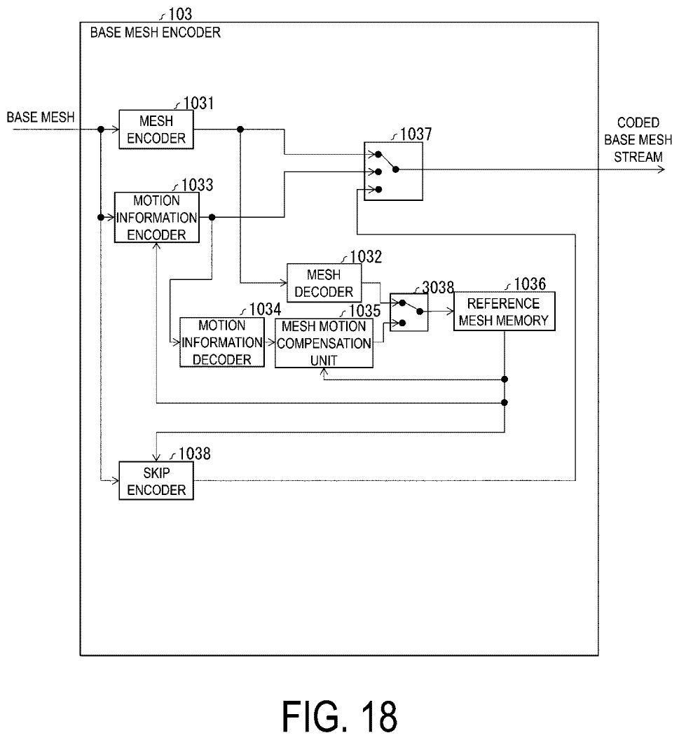

FIG. 18 is a functional block diagram illustrating a configuration of the base mesh encoder 103. The base mesh encoder 103 includes a mesh encoder 1031, a mesh decoder 1032, a motion information encoder 1033, a motion information decoder 1034, a mesh motion compensation unit 1035, a reference mesh memory 1036, a switch 1037, and a switch 1038. The base mesh encoder 103 may include a base mesh quantization unit (not illustrated) after the input of a base mesh. Each of the switches 1037 and 3038 is connected to the side where no motion compensation is performed in a case that the base mesh is to be encoded (intra-coded) without reference to other base meshes (for example, base meshes that have already been coded). On the other hand, the connection is switched to the side where motion compensation is performed in a case that the base mesh is to be encoded (inter-coded) with reference to another base mesh.

The mesh encoder 1031 has an intra coding function and intra-codes the base mesh, and outputs a coded base mesh stream. Draco or the like is used as a coding scheme.

The mesh decoder 1032 is similar to the mesh decoder 3031 and thus description thereof will be omitted.

The motion information encoder 1033 has an inter-coding function and inter-codes the base mesh and outputs a coded base mesh stream. Entropy coding such as arithmetic coding is used as a coding scheme.

The motion information decoder 1034 is similar to the motion information decoder 3032 and thus description thereof will be omitted.

The mesh motion compensation unit 1035 is similar to the mesh motion compensation unit 3033 and thus description thereof will be omitted.

The reference mesh memory 1036 is similar to the reference mesh memory 3034 and thus description thereof will be omitted.

### Coding of Mesh Displacements

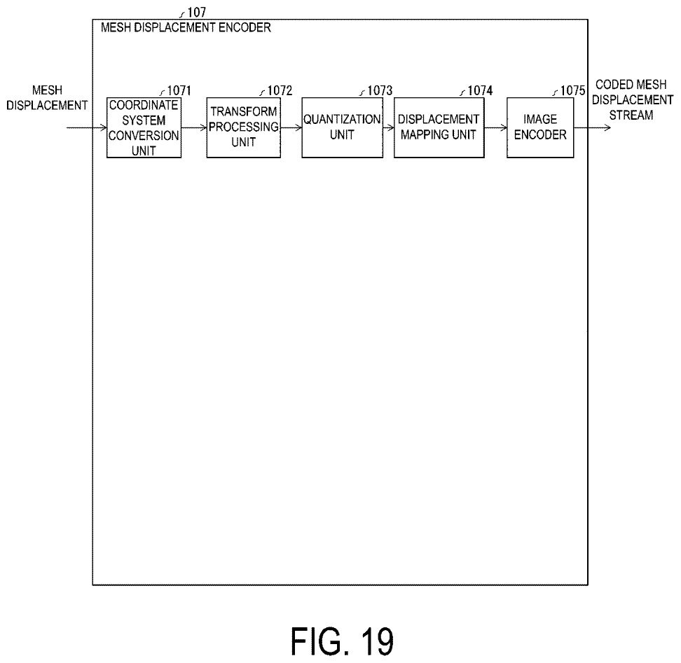

FIG. 19 is a functional block diagram illustrating a configuration of the mesh displacement encoder 107. The mesh displacement encoder 107 includes a coordinate system conversion unit 1071, a transform processing unit 1072, a quantizing unit 1073, and a displacement mapping unit 1074 (an image packer or a displacement coder). The mesh displacement encoder 107 may further include a video encoder 1075 as illustrated in FIG. 14. Alternatively, the video encoder 1075 may not be included in the mesh displacement encoder 107 and displacement image coding may be performed using an external image coding apparatus.

The coordinate system conversion unit 1071 converts the coordinate system for mesh displacements from a Cartesian coordinate system to a coordinate system for encoding displacements (for example, a local coordinate system) based on the value of coordinate conversion information displacementCoordinateSystem. Here, disp is a three-dimensional vector indicating a mesh displacement before coordinate system conversion, d is a three-dimensional vector indicating a mesh displacement after coordinate system conversion, and n_vec, t_vec, and b_vec are three-dimensional vectors (in the Cartesian coordinate system) corresponding to the axes of the local coordinate system.

```
if (displacementCoordinateSystem == 0) {
  d = disp
} else if (displacementCoordinateSystem == 1){
  d = (disp * n_vec, disp * t_vec, disp * b_vec)
}
```

The mesh displacement encoder 107 may update the value of displacementCoordinateSystem at a picture/frame level.

The syntax having the configuration of FIG. 9 is used in a case that displacementCoordinateSystem is encoded at a sequence level. asve_displacement_coordinate_system is set equal to 0 in a case of the Cartesian coordinate system and is set equal to 1 in a case of the local coordinate system.

The syntax having the configuration of FIG. 12 is used in a case that displacementCoordinateSystem is changed at a picture/frame level. afve_overriden_flag is set equal to 1 in a case that the coordinate system is updated and is set equal to 0 in a case that the coordinate system is not updated. afve_displacement_coordinate_system is set equal to 0 in a case of the Cartesian coordinate system and is set equal to 1 in a case of the local coordinate system.

The transform processing unit 1072 performs transform f (for example, wavelet transform) and derives a transformed mesh displacement Tdisp. The following is performed for pos=0 . . . NumDisp−1. Here, NumDisp is the number of mesh vertices.

$$dispCoeffArray [ v ] [ d ] = f ( d [ d ] [ v ] )$$

The quantization unit 1073 performs quantization based on a quantization scale value scale derived from the quantization parameter of each component of mesh displacements to derive a quantized mesh displacement dispQuantCoeffArray.

```
Vcount0 = 0
for( i = 0; i < subdivisionIterationCount; i++ ) {
  vcount1 = levelOfDetailCounts[ i ]
  for( v = vcount0; v < vcount1; v++ ) {
    for( d = 0; d < DisplacementDim; d++ ) {
      dispQuantCoeffArray[v][d] = dispCoeffArray[ v ][ d ] /
      iscale[ i ][ d ]
    }
  }
  vcount0 = vcount1
}
```

Alternatively, the scale value may be approximated by a power of 2 and dispQuantCoeffArray may be derived using the following expression.

```
Vcount0 = 0
for( i = 0; i < subdivisionIterationCount; i++ ) {
  scale[i] = 1 << scale2[i]
  vcount1 = levelOfDetailCounts[ i ]
  for( v = vcount0; v < vcount1; v++ ) {
    for( d = 0; d < DisplacementDim; d++ ) {
      dispQuantCoeffArray[v][d] = dispCoeffArray[v][d] >> scale2[i][d]
    }
  }
  vcount0 = vcount1
}
```

The displacement mapping unit 1074 generates an image dispQuantCoeffFrame from the quantized mesh displacement dispQuantCoeffArray based on the value of the displacement mapping parameter displacementChromaLocationType.

The displacement mapping unit 1074 may map a first component dispQuantCoeffArray[v][0] of the (quantized) mesh displacement array to a luma (Y) image component as follows. The following is applied to the width W and height H of the image (for y=0 . . . H−1 and x=0 . . . W−1).

H = origHeight
shift = (1 << bitDepth) >> 1
dispQuantCoeffFrame[x][ y][0] =
dispQuantCoefffArray[v][0] + shift
dispQuantCoeffFrame[x][ H+y][0] =
dispQuantCoeffArray[v][1] + shift
dispQuantCoeffFrame[x][2*H+y][0] =
dispQuantCoeffArray[v][2] + shift
v++
dispQuantCoeffFrame[x/2][ y/2][1] = shift
dispQuantCoeffFrame[x/2][H/2+y/2][1] = shift
dispQuantCoeffFrame[x/2][ H+y/2][1] = shift
dispQuantCoeffFrame[x/2][ y/2][2] = shift
dispQuantCoeffFrame[x/2][H/2+y/2][2] = shift
dispQuantCoeffFrame[x/2][ H+y/2][2] = shift

Alternatively, the displacement mapping unit 1074 may encode the mesh displacement for each submesh.

Note that the process may be switched depending on DecGeoChromaFormat. That is, the above process is performed in a case that DecGeoChromaFormat=1 (4:2:0) and the following process is performed in a case that DecGeoChromaFormat=3 (4:4:4).

$$dispQuantCoeffFrame [ x ] [ y ] [ d ] = dispQuantCoeffArray [ v ] [ 0 ]$$

$$dispQuantCoeffFrame [ x ] [ y ] [ d ] = dispQuantCoeffArray [ v ] [ 1 ]$$

$$dispQuantCoeffFrame [ x ] [ y ] [ d ] = dispQuantCoeffArray [ v ] [ 2 ]$$

$$v ++$$

The mesh displacement encoder 107 may update the values of origHeight and origWidth at a picture/frame level.

The video encoder 1075 encodes a YCbCr 4:2:0 format image including the (quantized) mesh displacement image and outputs a coded mesh displacement stream. VVC, HEVC, or the like is used as a coding scheme.

The video encoder 1075 may encode the mesh displacement image by dividing it into slices for each origHeight. origHeight may be aligned to a predetermined size according to the CTU size.

The video encoder 1075 may encode the mesh displacement image by assigning the first components (for example, D) of mesh displacements to the first slice, the second components (for example, U) to the second slice, and the third components (for example, V) to the third slice (displacementSliceType=1).

Further, the video encoder 1075 may also encode the mesh displacement image by assigning the first components of mesh displacements to the first slice and the second and third components to the second slice (displacementSliceType=2).

Processing can be simplified because assigning a different slice to each component of mesh displacements as described above allows the decoding apparatus to decode only some components of mesh displacements. A scalability function can also be realized because the decoding apparatus can decode slices containing the second and third components of mesh displacements as necessary. Also, even in a case that errors are mixed in coded data, error tolerance can be improved because the decoding apparatus can decode only slices (components) without errors.

Although embodiments of the present invention have been described above in detail with reference to the drawings, the specific configurations thereof are not limited to those described above and various design changes or the like can be made without departing from the spirit of the invention.

### Application Example

The 3D data coding apparatus 11 and the 3D data decoding apparatus 31 described above can be used by being installed in various apparatuses that transmit, receive, record, and reproduce 3D data. Note that the 3D data may be natural 3D data captured by a camera or the like or may be artificial 3D data (including CG and GUI) generated by a computer or the like.

An embodiment of the present invention is not limited to the embodiments described above and various changes can be made within the scope indicated by the claims. That is, embodiments obtained by combining technical means appropriately modified within the scope indicated by the claims are also included in the technical scope of the present invention.

### INDUSTRIAL APPLICABILITY

Embodiments of the present invention are suitably applicable to a 3D data decoding apparatus that decodes coded data into which 3D data has been encoded and a 3D data coding apparatus that generates coded data into which 3D data has been encoded. Embodiments of the present invention are also suitably applicable to a data structure for coded data generated by a 3D data coding apparatus and referenced by a 3D data decoding apparatus.

### REFERENCE SIGNS LIST

11 3D data coding apparatus
101 Atlas information encoder
1011 Mesh patch information encoder
1012 Submesh information encoder
1013 Extension information encoder
1014 Tile information encoder
1015 Parameter encoder
103 Base mesh encoder
1031 Mesh encoder
1032 Mesh decoder
1033 Motion information encoder
1034 Motion information decoder
1035 Mesh motion compensation unit
1036 Reference mesh memory
1037 Switch
1038 Switch
1039 Skip coding
104 Base mesh decoder
106 Mesh displacement update unit
107 Mesh displacement encoder
1071 Coordinate system conversion unit
1072 Transform processing unit
1073 Quantization unit
1074 Binarization unit
1075 Arithmetic encoder
1076 Context selection unit
1077 Context initialization unit
108 Mesh displacement decoder
109 Mesh reconstructor
110 Attribute update unit
111 Padder
112 Color space converter
113 Attribute encoder
114 Multiplexer
115 Mesh separator
1151 Mesh decimation unit
1152 Mesh subdivision unit
1153 Mesh displacement derivation unit
21 Network
31 3D data decoding apparatus
301 Demultiplexer
302 Atlas information decoder
3021 Parameter decoder
3022 Tile information decoder
3023 Extension information decoder
3024 Submesh information decoder
3025 Mesh patch information decoder
303 Base mesh decoder
3031 Mesh decoder
3032 Motion information decoder
3033 Mesh motion compensation unit
3034 Reference mesh memory
3035 Switch
3036 Switch
3037 Skip decoder
305 Mesh displacement decoder
3051 Arithmetic decoder
3052 De-binarization unit
3053 Inverse quantization unit
3054 Inverse transform processing unit
3055 Coordinate system conversion unit
3056 Context selection unit
3057 Context initialization unit
307 Mesh reconstructor
306 Attribute decoder
3071 Mesh subdivision unit
3072 Mesh deformation unit
308 Color space converter
41 3D data display apparatus

1. A 3D data decoding apparatus for decoding mesh data or point cloud data, the 3D data decoding apparatus comprising:
an atlas information decoder configured to decode atlas information from coded data in which the mesh data or the point cloud data is encoded, wherein
the atlas information includes tile/submesh mapping information.

2. The 3D data decoding apparatus according to claim 1, wherein
the atlas information decoder decodes, from the tile/submesh mapping information, a number of tiles, a tile ID with any index, a number of submeshes included in a tile having the tile ID, and a submesh ID with a submesh index included in the tile having the tile ID, and
derives a correspondence relationship between the submesh ID and the submesh index.

3. The 3D data decoding apparatus according to claim 1, wherein
the atlas information decoder decodes, from the tile/submesh mapping information, a number of submeshes, a submesh ID with any index, and a tile ID containing the submesh having the submesh ID, and
derives a correspondence relationship between the submesh index and the tile ID.

4. A 3D data coding apparatus for encoding mesh data or point cloud data, the 3D data coding apparatus comprising:
an atlas information encoder configured to encode atlas information, wherein
the atlas information encoder encodes the tile/submesh mapping information included in the atlas information.

5. The 3D data coding apparatus according to claim 4, wherein
the atlas information encoder encodes, from the tile/submesh mapping information, a number of tiles, a tile ID with any index, a number of submeshes included in a tile having the tile ID, and a submesh ID with a submesh index included in the tile having the tile ID.

6. The 3D data coding apparatus according to claim 4, wherein
the atlas information encoder encodes, from the tile-submesh mapping information, the number of submeshes, a submesh ID with any index, and a tile ID containing the submesh having the submesh ID.
